(19) United States
(12) Patent Application Publication
(10) Pub. No.: US 2023/0182073 A1
(43) Pub. Date: Jun. 15, 2023

(54) CO2 CAPTURE USING CARBONATE SORBENTS

(71) Applicant: California Institute of Technology, Pasadena, CA (US)

(72) Inventors: Alan Yalun GU, Pasadena, CA (US); Heng DONG, Pasadena, CA (US); Leopold DOBELLE, Pasadena, CA (US); Clement A. CID, Pasadena, CA (US); Michael R. HOFFMANN, Pasadena, CA (US)

(21) Appl. No.: 18/078,283

(22) Filed: Dec. 9, 2022

Related U.S. Application Data
(60) Provisional application No. 63/287,617, filed on Dec. 9, 2021.

(51) Int. Cl. B01D 53/82; B01D 53/62; B01D 53/83; B01D 53/02; B01D 53/96; B01J 20/04; B01J 20/34; B01J 20/28; B01J 20/30

(52) U.S. Cl. CPC B01D 53/82; B01D 53/62; B01D 53/83; B01D 53/02; B01D 53/96; B01J 20/043; B01J 20/3491; B01J 20/3483; B01J 20/28004; B01J 20/28019; B01J 20/3007; B01J 20/3028; B01D 2251/304; B01D 2251/306; B01D 2251/404; B01D 2258/0283; B01D 2257/504; B01D 2253/112; B01D 2253/304; B01D 2259/40001; B01D 2259/40083

(57) ABSTRACT

A system for capturing CO₂ gas comprising: a gaseous feed stream having an initial concentration of the CO₂ gas; wherein the gaseous feed stream is provided to a first reactor as a gaseous reaction stream; the first reactor comprising a sorbent composition and the gaseous reaction stream flowing therein, the gaseous reaction stream being in contact with the sorbent composition; and a first gaseous output stream having a concentration of CO₂ being less than the initial concentration of CO₂; wherein: the gaseous reaction stream comprises the CO₂ gas and is characterized by a relative humidity of at least 5%; the sorbent composition comprises a metal carbonate material that reacts with the CO₂ gas of the gaseous reaction stream thereby reducing CO₂ gas concentration; and the first reactor comprises 35 wt. % or less of liquid water by weight of sorbent and liquid water.

### CROSS-REFERENCE TO RELATED APPLICATIONS

This application claims the benefit of priority to U.S. Provisional Patent Application No. 63/287,617, filed Dec. 9, 2021, which is hereby incorporated by reference in its entirety.

### BACKGROUND OF INVENTION

While removing CO₂ from the atmosphere and reducing CO₂ emission into the atmosphere are of utmost importance, significant technological and economic challenges have limited development of associated technologies. There are approaches for capturing CO₂ directly from the atmosphere and there are approaches for capturing CO₂ at emission sources to reduce further accumulation of CO₂ in the atmosphere.

For example, extracting CO₂ from point source emitters such as coal and gas powerplants and refineries leverages the high CO₂ concentration in the flue gas to achieve economical carbon capture with small footprint. The current benchmark technology of CO₂ capture at point sources is amine scrubbing. However, amine scrubbing suffers from high energy consumption due to the large heat capacity of the aqueous amine solution in thermal cycling. Solid sorbents on porous supports have lower heat capacities, but may introduce diffusion limitation and/or abrasion dust waste. Attrition of the sorbent and/or support material creates a waste stream difficult to be recycled in fluidized bed systems, and condensation of liquid water inside microporous channels of the support increases regeneration energy consumption in fixed bed systems.

The systems and methods disclosed herein address these and other challenges in the art. Aspects of the invention disclosed here are useful for direct CO₂ capture from air and CO₂ capture from point source emitters.

### SUMMARY OF THE INVENTION

Provided herein are systems and methods for capturing CO₂ gas from a gaseous feed stream, such as air or a flue gas. Aspects of the systems and methods disclosed herein CO₂ capture efficiency that is equivalent or better than existing technologies while being significantly more economical. This is achieved, for example, by reducing waste or loss of sorbent material through features such as reduction of a waste slurry stream having spent-sorbent material by using non-deliquescent metal carbonate as sorbent, reduction of condensed water vapor in the gaseous reaction stream in the reactor, and/or the collection, regeneration, and reuse of spent sorbent material. For example, in some aspects, non-deliquescent metal carbonate materials such as Group II metal carbonates, such as CaCO₃, are used as sorbent material to reduce the amount of metal carbonate and/or spent-sorbent (e.g., metal bicarbonate) that may dissolve in any liquid water present in the reactor, thereby avoiding or reducing production of a waste slurry stream having spent-sorbent material. For example, reducing the amount of water present in the reactor in-turn reduces the amount of sorbent and/or spent-sorbent that may be dissolved or suspended in the water, thereby reducing loss of sorbent material. In some aspects, the latter is achieved by reduction or elimination of condensed water vapor in the gaseous reaction stream in the reactor by pre-treating the feed stream to remove liquid water and/or by adjusting the temperature and/or pressure of the gaseous stream in the reactor to conditions that disfavor water condensation (e.g., temperature above dew point). In some aspects, loss of sorbent material is achieved by the collection of spent sorbent material, even if it is in the form of aerosolized dust, regeneration, and reuse of spent sorbent material, such as by decomposition of metal bicarbonate into metal carbonate and optionally subsequent granulation and/or spheronization followed by recycling the regenerated metal carbonate back into the reactor.

Aspects disclosed herein include, a system for capturing CO₂ gas, the system comprising: a gaseous feed stream having an initial concentration of the CO₂ gas;

wherein the gaseous feed stream is directly or indirectly provided to a first reactor as a gaseous reaction stream; the first reactor comprising a sorbent composition and the gaseous reaction stream flowing therein, the gaseous reaction stream being in contact with the sorbent composition; and a first gaseous output stream that exists the first reactor, the first gaseous output stream having a concentration of CO₂ being less than the initial concentration of CO₂ in the gaseous feed stream; wherein: the gaseous reaction stream comprises the CO₂ gas and is characterized by a relative humidity of at least 5%; the sorbent composition comprises a metal carbonate material that reacts with the CO₂ gas of the gaseous reaction stream thereby reducing CO₂ gas concentration in the gaseous reaction stream; and wherein: (a) the first reactor comprises 35 wt. % or less of liquid water by weight of the sorbent composition and the liquid water; and/or (b) the gaseous reaction stream has 35 wt. % or less of condensed water by weight of the gaseous reaction stream immediately prior to entering the first reactor or immediately prior to initial contact with the sorbent composition upon entering the first reactor. Optionally, the first reactor comprises 5 wt. % or less of liquid water by weight of the sorbent composition and the liquid water. Optionally, gaseous reaction stream has 35 wt. % or less of condensed water by weight of the gaseous reaction stream immediately prior to entering the first reactor or immediately prior to initial contact with the sorbent composition upon entering the first reactor. Optionally, the system comprises a feed pre-treatment subsystem configured to pre-treat the gaseous feed stream thereby forming a pre-treated gaseous stream which is provided to the first reactor; wherein the gaseous reaction stream is the pre-treated gaseous stream that enters the first reactor; and wherein the feed pre-treatment subsystem comprises a water-removal device configured to remove liquid water from the gaseous feed stream prior to the reactor.

Aspects disclosed herein include, a system for capturing CO₂ gas, the system comprising: a gaseous feed stream having an initial concentration of the CO₂ gas; wherein the gaseous feed stream is directly or indirectly provided to a first reactor as a gaseous reaction stream; the first reactor comprising a sorbent composition and the gaseous reaction stream flowing therein, the gaseous reaction stream being in contact with the sorbent composition; and a first gaseous output stream that exists the first reactor, the first gaseous output stream having a concentration of CO₂ being less than the initial concentration of CO₂ in the gaseous feed stream; wherein: the gaseous reaction stream comprises the CO₂ gas and is characterized by a relative humidity of at least 5%; the sorbent composition comprises at least one metal carbonate material that reacts with the CO₂ gas of the gaseous reaction stream thereby reducing CO₂ gas concentration in the gaseous reaction stream; and the sorbent composition further comprises one or more additives. Optionally, the one or more additives comprise one or more binders, one or more pore expanders, one or more cross-linkers, one or more lubricants, one or more extrusion aids, or any combination thereof. Optionally, at least one of the one or more additives is a synthetic organic compound and/or is not an inorganic mineral.

Aspects disclosed herein include, a system for capturing CO₂ gas, the system comprising: a gaseous feed stream having an initial concentration of the CO₂ gas; wherein the gaseous feed stream is directly or indirectly provided to a first reactor as a gaseous reaction stream; the first reactor comprising a sorbent composition and the gaseous reaction stream flowing therein, the gaseous reaction stream being in contact with the sorbent composition; a first gaseous output stream that exists the first reactor, the first gaseous output stream having a concentration of CO₂ being less than the initial concentration of CO₂ in the gaseous feed stream; and a sorbent-regeneration subsystem; wherein: the gaseous reaction stream comprises the CO₂ gas and is characterized by a relative humidity of at least 5%; the sorbent composition comprises a metal carbonate material that reacts with the CO₂ gas of the gaseous reaction stream thereby reducing CO₂ gas concentration in the gaseous reaction stream; a spent-sorbent composition from the first reactor is provided to a sorbent-regeneration subsystem; the spent-sorbent composition comprises a metal bicarbonate material formed in the first reactor as a result of the reaction of the metal carbonate material with the CO₂ gas; the sorbent-regeneration subsystem converts the provided spent-sorbent composition to a regenerated-sorbent composition; and the regenerated-sorbent composition is recycled back to the first reactor. Optionally, the sorbent-regeneration subsystem comprises granulation such that the regenerated-sorbent composition has a larger particulate size than the spent-sorbent composition.

Aspects disclosed herein include, a method for capturing CO₂ gas, the method comprising: feeding, directly or indirectly, a gaseous feed stream having an initial concentration of the CO₂ gas to a first reactor as a gaseous reaction stream; wherein the first reactor comprises a sorbent composition and the gaseous reaction stream flowing therein, the gaseous reaction stream being in contact with the sorbent composition; wherein the gaseous reaction stream comprises the CO₂ gas and is characterized by a relative humidity of at least 5%; and wherein the sorbent composition comprises a metal carbonate material; and reacting the CO₂ gas in the gaseous reactions stream with the metal carbonate material thereby thereby reducing CO₂ gas concentration in the gaseous reaction stream; wherein a first gaseous output stream exists the first reactor, the first gaseous output stream having a concentration of CO₂ being less than the initial concentration of CO₂ in the gaseous feed stream; and wherein: (a) the first reactor comprises 35 wt. % or less of liquid water by weight of the sorbent composition and the liquid water; and/or (b) the gaseous reaction stream has 35 wt. % or less of condensed water by weight of the gaseous reaction stream immediately prior to entering the first reactor or immediately prior to initial contact with the sorbent composition upon entering the first reactor. Optionally, the first reactor comprises 5 wt. % or less of liquid water by weight of the sorbent composition and the liquid water. Optionally, gaseous reaction stream has 35 wt. % or less of condensed water by weight of the gaseous reaction stream immediately prior to entering the first reactor or immediately prior to initial contact with the sorbent composition upon entering the first reactor. Optionally, the method further comprises pre-treating the gaseous feed stream to remove liquid/condensed water from the gaseous feed stream, further optionally immediately prior to its entering the first reactor or immediately prior to initial contact with the sorbent composition in the first reactor. Optionally, the method further comprises heating the gaseous feed stream to a temperature greater than its dew point. Optionally, the heating of the gaseous feed stream is performed prior to its entering the reactor. Optionally, the method further comprises heating the gaseous reaction stream in the first reactor to a temperature greater than its dew point in the first reactor. Optionally, the method further comprises controlling a temperature and/or pressure in the reactor to prevent water condensation such that gaseous feed stream has a temperature greater than its dew point in the first reactor.

Aspects disclosed herein include, a method for capturing CO₂ gas, the method comprising: feeding, directly or indirectly, a gaseous feed stream having an initial concentration of the CO₂ gas to a first reactor as a gaseous reaction stream; wherein the first reactor comprises a sorbent composition and the gaseous reaction stream flowing therein, the gaseous reaction stream being in contact with the sorbent composition; wherein the gaseous reaction stream comprises the CO₂ gas and is characterized by a relative humidity of at least 5%; and wherein the sorbent composition comprises at least one metal carbonate material and one or more additives; and reacting the CO₂ gas in the gaseous reactions stream with the at least one metal carbonate material thereby reducing CO₂ gas concentration in the gaseous reaction stream; wherein a first gaseous output stream exists the first reactor, the first gaseous output stream having a concentration of CO₂ being less than the initial concentration of CO₂ in the gaseous feed stream.

Aspects disclosed herein include, a method for capturing CO₂ gas, the method comprising: feeding, directly or indirectly, a gaseous feed stream having an initial concentration of the CO₂ gas to a first reactor as a gaseous reaction stream; wherein the first reactor comprises a sorbent composition and the gaseous reaction stream flowing therein, the gaseous reaction stream being in contact with the sorbent composition; wherein the gaseous reaction stream comprises the CO₂ gas and is characterized by a relative humidity of at least 5%; and wherein the sorbent composition comprises a metal carbonate material; reacting the CO₂ gas in the gaseous reactions stream with the metal carbonate material thereby reducing CO₂ gas concentration in the gaseous reaction stream; wherein a first gaseous output stream exists the first reactor, the first gaseous output stream having a concentration of CO₂ being less than the initial concentration of CO₂ in the gaseous feed stream; and wherein a spent-sorbent composition comprising a metal bicarbonate material is formed in the first reactor as a result of the reaction of the metal carbonate material with the CO₂ gas; regenerating the sorbent composition via a sorbent-regeneration subsystem by converting the provided spent-sorbent composition to a regenerated-sorbent composition; and recycling the regenerated-sorbent composition back to the first reactor. Optionally, the step of regenerating comprises granulating, via granulation, such that the regenerated-sorbent composition has a larger particulate size than the spent-sorbent composition. Optionally, the step of regenerating comprises decomposing the metal bicarbonate material (of the spent-sorbent composition) to reform the metal carbonate material. Optionally, the step of regenerating comprises granulating, via granulation, the reformed metal carbonate material to make the regenerated-sorbent composition having a larger particulate size than the (collected) spent-sorbent composition and/or than an initial average particular size of the reformed metal carbonate material.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIGS. 1A-1B: Schematics each illustrating a fixed bed reactor of a CO₂ capture system, according to some aspects disclosed herein.

FIGS. 2A-2B: Schematics of a fixed bed reactor of a CO₂ capture system, according to some aspects disclosed herein. FIG. 2A includes a cutout showing that sorbent composition particulates packed inside the reactor. FIG. 2B is a cross-section schematic of the reactor of FIG. 2A, showing exemplary dimensions of an experimental reactor, according to some embodiments herein.

FIG. 3A: Process flow illustration of a CO₂ capture system (300(I)), according to some aspects disclosed herein.

FIG. 3B: Process flow illustration of a CO₂ capture system (300(II)), optionally having a circulating fluidized bed reactor, according to some aspects disclosed herein.

FIG. 4: Photograph of an experimental fluidized bed reactor, according to some aspects disclosed herein.

FIG. 5: Photograph of an experimental fixed bed reactor system, according to some aspects disclosed herein.

FIG. 6: Schematics of humidification device, for a feed pre-treatment subsystem, according to some aspects disclosed herein.

FIG. 7: Process flow diagram illustrating an applied example of a CO₂ capture system, according to some aspects disclosed herein.

FIG. 8: Schematic showing an exemplary process for making a multi-ingredient sorbent composition, according to some aspects.

FIGS. 9A-9N: Exemplary mixtures used with some multi-ingredient formation processes, according to aspects herein, and photographs of corresponding resulting sorbent compositions.

FIGS. 10A-10B: Tables detailing exemplary processes and mixtures, according to some aspects, used to make multi-ingredient sorbent compositions.

FIG. 11A: Data plot of CO₂ partial pressure (bar) at the outlet of a fixed bed reactor, according to some aspects herein, as a function of time. CO₂ absorption performance is shown with simulated flue gas on 0.053 mm K₂CO₃ granular sorbent in a fixed bed configuration. The simulated flue gas is 10% CO₂ and 90% Argon by volume at 60 degrees Celsius. The fixed bed reactor is held at 60 degrees Celsius and atmospheric pressure. The CO₂ partial pressure at the inlet and outlet of the fixed bed are measured by a quadruple mass spectrometer (e.g., Hiden Analytics). Regeneration of the granular sorbent is performed at 160 degrees Celsius and atmospheric pressure between each absorption cycle (as shown in FIG. 11B).

FIG. 11B: Data plot of CO₂ partial pressure (bar) at the outlet of a fixed bed reactor used for regeneration of the sorbent composition and release of CO₂ from spent-sorbent, according to some aspects herein. CO₂ release/desorption with sweep gas of the granular sorbent in FIG. 11A in a fixed bed configuration. The simulated sweep gas is 10% CO₂ and 90% Argon by volume at 160 degrees Celsius. The fixed bed reactor is held at 160 degrees Celsius and atmospheric pressure. The CO₂ partial pressure at the inlet and outlet of the fixed bed are measured by a quadruple mass spectrometer (e.g., Hiden Analytics). CO₂ absorption is performed on these granular sorbent at 60 degrees Celsius and atmospheric pressure between each regeneration cycle (as shown in FIG. 11A).

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The term “sorbent” refers to a material or composition capable of absorbing, adsorbing, chemisorbing (chemisorption), physisorbing (physisorption), uptaking, binding, arresting, or otherwise capturing CO₂. In aspects, a sorbent or sorbent composition comprises one or more metal carbonate materials (e.g., CaCO₃) which react with CO₂, in the presence of H₂O, to bind or capture CO₂ in the form of a metal bicarbonate material. In some aspects, a sorbent or sorbent composition comprises one or more metal carbonate materials only. In some aspects, a sorbent or sorbent composition consists essentially of one or more metal carbonate materials. In some aspects, a sorbent or sorbent composition comprises only one metal carbonate material. In some aspects, a sorbent or sorbent composition comprises consists essentially of one metal carbonate material. In some aspects, a sorbent or sorbent composition consists of one or more metal carbonate materials. In some aspects, a sorbent or sorbent composition consists of one metal carbonate material. In some aspects, a sorbent or sorbent composition comprises one or more metal carbonate materials, and further optionally comprises one or more additives mixed with the one or more metal carbonate materials. The one or more additives include, but are not limited to, one or more binders, one or more pore expanders, one or more cross-linkers, one or more lubricants, one or more extrusion aids, or any combination thereof. In some aspects, the one or more additives are selected from the group consisting of one or more binders, one or more pore expanders, one or more cross-linkers, one or more lubricants, one or more extrusion aids, and any combination thereof.

A gas or gaseous stream may comprise “condensed water” or “liquid water” carried by, aerosolized in, and/or suspended in the gas or gaseous stream. As used herein, in such context, these terms “condensed water” and “liquid water” are equivalent and used interchangeably. In aspects for example, condensed water in a gas or gaseous stream is in the form of liquid water droplets carried by, aerosolized in, and/or suspended in the gas or gaseous stream. A gaseous stream may be characterized as having a particular weight fraction or weight percent (wt. %) of condensed water, which is a percent corresponding to the weight fraction of H₂O/(H₂O+CO₂+(other gaseous components and suspended/aerosolized components in the gas stream)).

The terms “fluidized bed reactor” and “fixed bed reactor” are intended to be consistent with the terms as known by those skilled in the art, such as chemical engineering.

The term “particles” or “particulates” refers to small solid objects that may be dispersed and/or suspended in a fluid, such as a gas or liquid (e.g., in a gaseous stream or liquid water). For example, a slurry includes particles dispersed and/or suspended therein. The terms “particle” and “particulate” may be used interchangeably. In some aspects, each of the interchangeable terms “particle” and “particulate” inclusively refers to an individual primary particle, an individual aggregate, an individual agglomerate, or an individual granule comprising aggregate(s) and/or agglomerate(s) of primary particles. In some aspects, for primary particles that are part of an aggregate, agglomerate, granule, or the like, the term particulate refers to the respective aggregate, agglomerate, granule, or the like thereof. Merely as an illustrative example, a hypothetical slurry consisting only of water and 1000 granules suspended therein, may be characterized as having 1000 particulates, even though each granule may itself comprise some number of primary particles. For example, in aspects, the term “particulates” refers (i) to primary particles that are not part of aggregates, agglomerates, or granules, (ii) to aggregates that are not part of agglomerates or granules, (iii) to agglomerates that are not part of granules, and (iv) to granules. Aggregates and agglomerates may be referred to as secondary particles because they comprise primary particles. An agglomerate comprises at least one primary particle and/or at least one aggregate. For example, in aspects, primary particles and/or aggregates of an agglomerate may be held together by adhesion or other weak physical interactions. A particle or particulate can be any material created by the act of friction, for example, when two surfaces come into mechanical contact and there is mechanical movement, and/or heat (e.g., sintering), and/or pressure. Particles that are agglomerates and/or aggregates and/or granules may include, but are not limited to, dust, dirt, smoke, ash, soot, powder, pills, pellets, granules, or any combination of these or other materials or contaminants. In some aspects, for example, granules have a characteristic size selected of at least 0.1 mm, optionally at least 0.2 mm, optionally at least 0.3 mm, optionally at least 0.5 mm, optionally at least 0.7 mm, optionally at least 0.9 mm, optionally at least 1 mm, optionally selected from the range of 0.5 mm to 1.5 cm. In some aspects, for example, granules have an average characteristic size selected of at least 0.1 mm, optionally at least 0.2 mm, optionally at least 0.3 mm, optionally at least 0.5 mm, optionally at least 0.7 mm, optionally at least 0.9 mm, optionally at least 1 mm, optionally selected from the range of 0.5 mm to 1.5 cm.

The term “average particular size” refers to an average of a size characteristic of a set of particulates, such as particulates in a gaseous stream or particulates in a slurry. The term “size characteristic” refers to a property, or set of properties, of a particle that directly or indirectly relates to a size attribute. According to some embodiments, a size characteristic corresponds to an empirically-derived size characteristic of a particle(s) being detected, such as a size characteristic based on, determined by, or corresponding to data from any of the probes disclosed herein or other art-known probes capable of detecting particles (e.g., a size characteristic corresponding to a spherical particle exhibiting similar or substantially same properties, such as aerodynamic, hydrodynamic, optical, and/or electrical properties, as the particle(s) being detected). According to some aspects, a size characteristic corresponds to a physical dimension, such as a cross-sectional size (e.g., length, width, thickness, diameter).

The term “bara” refers to the bar unit of measure of absolute pressure. In other words, 1 bara is 1 bar absolute. This is in contrast to barg, which corresponds to bar gauge.

The terms “wt. %”, “% wt”, “weight percent”, “percent by weight”, “% by weight”, and equivalent are used herein interchangeably to refer to a weight percent, or percent by weight, of a component. For example, weight percent may be used to characterize a relative amount of a component in a solid mixture, in a fluid mixture, or in a fluid stream, for example. For example, weight percent may be used to characterize a relative amount of a component such as liquid water suspended in a gaseous stream. Weight percent of a component may be characterized more particularly with respect to one or more certain other components. As used herein, reference to “percent [or, %, wt. %] by weight of the sorbent composition and the liquid water” and “percent [or, %, wt. %] relative to weight of the sorbent composition and the liquid water” interchangeably refers to a weight of a component relative to the weight of sorbent and liquid water expressed as a percent. For example, a reactor may be characterized as containing X (e.g., X=30) percent [or, %, wt. %] of liquid water by weight of sorbent composition and liquid water, where X is a number, which corresponds to the equation Eq. 1:

X=100%*[(weight of liquid H₂O(liq) in reactor)/(total weight of all water-soluble components of the sorbent composition+weight of liquid H₂O(liq) in said same reactor)] (Eq. 1).

In Eq. 1, “total weight of all water-soluble components of the sorbent composition” includes sum weight of each metal carbonate material that is water-soluble, each additive that is water-soluble, and each support material that is water-soluble. In some aspects, and for the purpose of Eq. 1, a material or component, including but not limited to a metal carbonate material, an additive, and a support, is “water-soluble” if its solubility in water is 1 g/L or more at approximately STP (standard temperature and pressure, or 1 atm absolute and 20 ° C.). As used herein, reference to “percent [or, %, wt. %] by weight of gaseous [e.g., reaction, feed, etc.] stream” and “percent [or, %, wt. %] relative to weight of the gaseous [e.g., reaction, feed, etc.] stream” interchangeably refers to a weight of a component relative to the weight of components of the gaseous [e.g., reaction, feed, etc.] stream expressed as a percent. For example, a gaseous reaction stream may be characterized as containing Y (e.g., Y=5) percent [or, %, wt. %] of liquid water by weight of the gaseous reaction stream, where Y is a number, which corresponds to the equation Eq. 2:

Y=100%*[(weight of liquid H₂O(liq) in the gaseous stream)/(weight of all components in said same gaseous stream including liquid H₂O(liq), vapor H₂O(g), CO₂(g), and any other gas components such as O₂(g), N₂(g), SOₓ(g), NOₓ(g), etc., if present)] (Eq. 2).

In some aspects, weight percent of liquid water in a gaseous stream relative to weight of the gaseous stream is at a given time in a given volume. Optionally, in some aspects, a weight percent of liquid water in a gaseous stream relative to weight of the gaseous stream may be expressed or measured as Eq. 3:

Y=100%*[(mass flow rate of liquid H₂O(liq) in the gaseous stream)/(mass flow rate of all components in said same gaseous stream including liquid H₂O(liq), vapor H₂O(g), CO₂(g), and any other gas components such as O₂(g), N₂(g), SOₓ(g), NOₓ(g), etc., if present)] (Eq. 3).

In some aspects, Eq. 3 and Eq. 2 are equivalent as the measurement or calculation of each component of the respective equation is performed at the same time, area, and/or volume (e.g., simultaneously). Optionally, in some aspects, a weight percent of liquid water in a gaseous stream relative to weight of the gaseous stream may be expressed or measured as Eq. 4:

Y=100%*[(mass flux of liquid H₂O(liq) in the gaseous stream)/(mass flux of all components in said same gaseous stream including liquid H₂O(liq), vapor H₂O(g), CO₂(g), and any other gas components such as O₂(g), N₂(g), SOₓ(g), NOₓ(g), etc., if present)] (Eq. 4).

In some aspects, Eq. 4, Eq. 3, and Eq. 2 are equivalent as the measurement or calculation of each component of the respective equation is performed at the same time, area, and/or volume (e.g., simultaneously).

The term “approximately” refers to a property, condition, or value that is within 20%, 10%, within 5%, within 1%, optionally within 0.1%, or is equivalent to a reference property, condition, or value. The terms “about”, “approximately”, and “substantially” are interchangeable and have identical means. The term “approximately equal”, “approximately equivalent”, or “approximately unchanged”, when used in conjunction with a reference value describing a property or condition, refers to a value that is within 20%, within 10%, optionally within 5%, optionally within 1%, optionally within 0.1%, or optionally is equivalent to the provided reference value. For example, a diameter is approximately equal to 100 nm (or, “is approximately 100 nm”) if the value of the diameter is within 20%, optionally within 10%, optionally within 5%, optionally within 1%, within 0.1%, or optionally equal to 100 nm. The term “substantially greater”, when used in conjunction with a reference value describing a property or condition, refers to a value that is at least 1%, optionally at least 5%, optionally at least 10%, or optionally at least 20% greater than the provided reference value. The term “substantially less”, when used in conjunction with a reference value describing a property or condition, refers to a value that is at least 1%, optionally at least 5%, optionally at least 10%, or optionally at least 20% less than the provided reference value.

The term “and/or” is used herein, in the description and in the claims, to refer to a single element alone or any combination of elements from the list in which the term and/or appears. In other words, a listing of two or more elements having the term “and/or” is intended to cover embodiments having any of the individual elements alone or having any combination of the listed elements. For example, the phrase “element A and/or element B” is intended to cover embodiments having element A alone, having element B alone, or having both elements A and B taken together. For example, the phrase “element A, element B, and/or element C” is intended to cover embodiments having element A alone, having element B alone, having element C alone, having elements A and B taken together, having elements A and C taken together, having elements B and C taken together, or having elements A, B, and C taken together.

The term “at most” is equivalent to “equal to or less than”.

The term “±” refers to an inclusive range of values, such that “X±Y,” wherein each of X and Y is independently a number, refers to an inclusive range of values selected from the range of X-Y to X+Y. In the cases of “X±Y” wherein Y is a percentage (e.g., 1.0±20%), the inclusive range of values is selected from the range of X-Z to X+Z, wherein Z is equal to X(Y/100). For example, 1.0±20% refers to the inclusive range of values selected from the range of 0.8 to 1.2.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

Combined, US point sources emit annually 3+ Gt CO₂ equivalent, approximately 50% of the country's CO₂ emissions. Extracting CO₂ from point source emitters such as coal and gas powerplants and refineries leverages the high CO₂ concentration in the flue gas to achieve economical carbon capture with small footprint. Compared to direct air capture and the amine-based point source capture technologies, our proposed carbonate — bicarbonate cycle can be the most inexpensive and easy to implement solution to extract pure CO₂ from point source emitters. CO₂ can be absorbed by metal carbonate and convert it to bicarbonate in the presence of moisture. The bicarbonate solid is recycled and regenerated at temperatures between 60° C. and 160° C. through a circulating fluidized bed. The extracted and purified CO₂ can be sequestered or used as a feedstock for green chemistry.

The current benchmark technology of CO₂ capture at point sources is amine scrubbing, which suffers from high energy consumption due to the large heat capacity of the aqueous amine solution in thermal cycling. Solid sorbents on porous supports have lower heat capacities, but introduce diffusion limitation or abrasion dust waste. In particular, carbonate CO₂ sorbents have been deposited onto porous supports for carbon capture in both fixed bed reactors¹⁻³ and fluidized bed reactors⁴⁻⁵. However, attrition of the support material creates a waste stream difficult to be recycled in fluidized bed systems, and condensation of liquid water inside microporous channels of the support increases regeneration energy consumption in fixed bed systems. The few examples⁶⁻¹⁰ using carbonate sorbent without a porous support used group I metal carbonate which are all soluble in water, causing humidity to condense into the liquid phase, resulting in quickly degrading structural integrity through temperature cycling as well as high energy input for sorbent regeneration.

Aspects disclosed herein include:
1. A CO₂ sorbent based on calcium carbonate without support in both fixed bed and (circulating) fluidized bed reactor systems, and
2. A CO₂ sorbent based on metal carbonate including but not limited to lithium carbonate, sodium carbonate, potassium carbonate and rubidium carbonate without support in (circulating) fluidized bed reactor systems.

In the first aspect listed above, calcium carbonate is insoluble in water, and calcium bicarbonate is only slightly soluble. Neither is deliquescent like the group 1 metal carbonates and bicarbonates. Hence the sorbent does not induce water condensation into the liquid phase as much as the prior art does, resulting in stable reactor system operation for both fixed and fluidized bed reactor systems.

In the second aspect listed above, the vigorous mixing and short contact time between the CO₂-containing gas and the carbonate sorbent solid in a fluidized bed reduces water vapor condensation, enabling the use of all carbonates, including hygroscopic ones such as potassium carbonate, to capture CO₂.

A reaction for CO₂ capture and sorbent regeneration can be written as, for example:

MCO₃₍ₛ₎+CO_{2(g)}+H₂O_{(g)}↔M(HCO₃)₂₍ₛ₎, where M is an alkaline (e.g. Na, K) or alkaline earth (e.g. Ca) metal.

In some aspects, for example, a fixed bed reactor of a CO₂ capture system, according to aspects herein, can use CaCO₃ particles of greater than 100 μm size and a heater to regenerate the sorbent. The regeneration may be accomplished also by the use of a pair of reactors with temperature swing. The airflow may also be directed radially instead of axially as shown in the figure. In some aspects, for example, a fluidized bed reactor of a CO₂ capture system, according to aspects herein, can use CaCO₃ particles of 30-2000 μm in size as the sorbent composition.

Compared to a fixed bed, a fluidized bed allows vigorous mixing between the solid sorbent and gaseous reactants, substantially reducing mass and heat transport limitations that are often the rate-determining step of CO₂ adsorption in a fixed bed. A fluidized bed can also accept higher flow rate than a fixed bed, making it advantageous for large-scale implementation. However, a fluidized bed may require more energy for fluidization and solid-gas separation than a fixed bed, and sorbent attrition is more significant. In some aspects herein, using a single-ingredient sorbent composition, such as having one metal carbonate composition, offers a significant advantage, which is that having the single-ingredient facilitates economical regeneration and recycling schemes, according to some aspects herein. For example, sorbent fine dust can be regenerated and then recycled using granulation, reducing the cost of replacing sorbent to nearly zero. The granular recycled sorbent can be activated into a porous structure, optionally, or processed into granules using a granulator.

Aspects described herein are capable of direct air capture. Some aspects described herein are particularly well suited for point source captures such as flue gas treatment due to its high temperature and moisture content. Impurities such as SOₓ and NOₓ may be removed using existing technologies such as a water bath, which also adds humidity to the flue gas. Typical flue gas temperature ranges 110 to 500° C., which may be used to provide the energy to the fluidized bed reactors through a series of heat exchangers. Considering the small difference between a capture temperature of approximately 60° C., for example, and a regeneration temperature of approximately 160° C., for example, as well as the small heat capacity of a dry carbonate solid, the regenerated sorbent may be air-cooled to optimal capture temperature without additional cooling. Hence, the optimized temperature cycling may achieve zero or near-zero emission.

Compared to the existing technology of amine scrubbing, carbonate sorbents cost 5%-20% of monoethanolamine ($50-$200/ton vs $1000/ton). The energy consumption for the temperature cycling of carbonate sorbents is estimated to be 20% of that required for amine scrubbing temperature cycling. No toxic waste is produced by the carbonates reacting with SOₓ and NOₓ, as opposed to amine, which is toxic in its original form and its carbonate/sulfate/nitrate forms.

Compared to calcium looping with similar sorbent chemical composition, the operating temperature is much lower (60° C.-160° C. vs 600° C.-800° C.), which translates to much lower energy cost. The lower temperature also allows the use of waste heat from industrial processes where CO₂ emission originates, enabling near zero net emission for the temperature swing. In addition, workplace safety is improved by eliminating very high temperature operation.

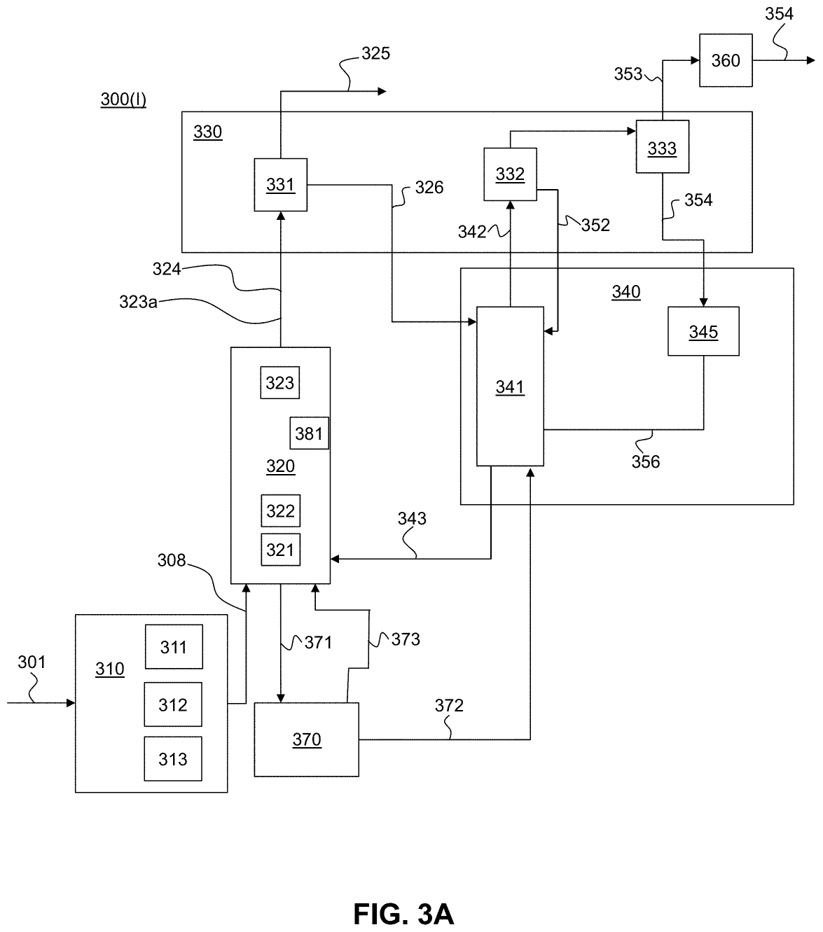

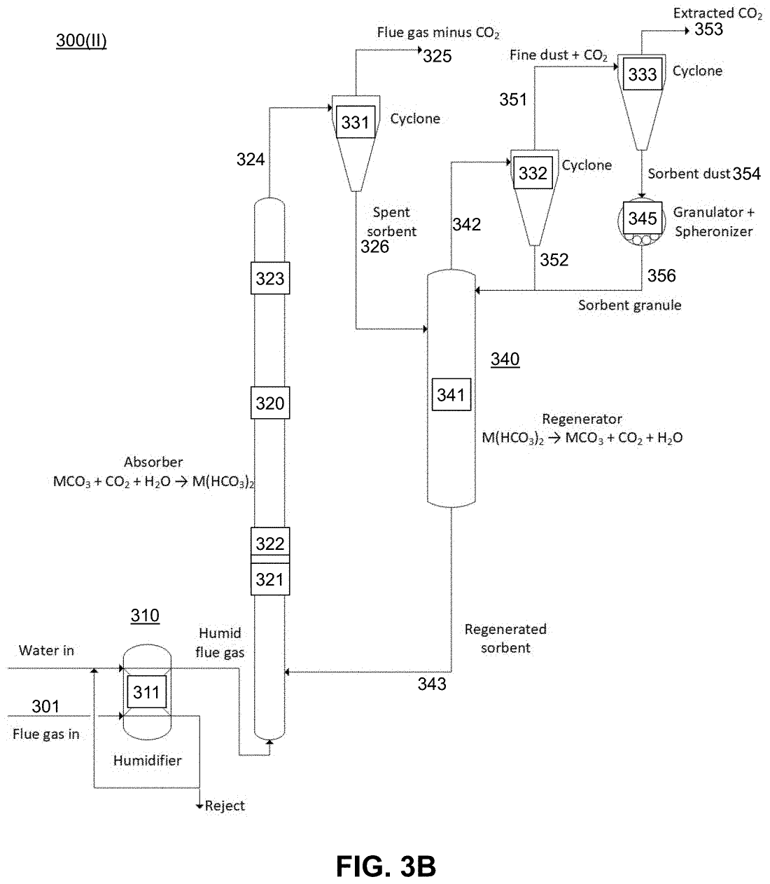

A process flow illustration of a system 300(I) for capturing CO₂, optionally having a circulating fluidized bed reactor and/or a fixed bed reactor, according to some aspects disclosed herein, is shown in FIG. 3A.

A gaseous feed stream 301 containing CO₂, such as a flue gas, is optionally pre-treated in a feed pre-treatment subsystem 310. Feed pre-treatment subsystem optionally has a humidifier 311 to increase the water vapor content of the gaseous feed stream 310, thereby forming a pre-treated gaseous feed stream 308, prior to its entering first reactor 320 as a gaseous feed stream 321. Optionally, in some aspects, feed pre-treatment subsystem 310 comprises a water-removal device 312, such as cold trap, an elbow or dip in the line, a float valve, and/or a steam trap, and combination of these, or such. Optionally, in some aspects, feed pre-treatment subsystem 310 comprises a heat exchanger(s) 313 configured to heat and/or cool the feed stream to facilitate forming a pre-treated gaseous feed stream having a high humidity and minimal or negligible liquid water content. Heat exchanger(s) 313 may comprise a heater, for example, to raise the pre-treated gas to a temperature above its dew point. Heat exchanger(s) 313 may comprise a cooler, for example, to cool the pre-treated gas to an acceptable temperature for the first reactor 320 and/or to condensed excess water prior to first reactor 320.

Upon entering first reactor 320, pre-treated gaseous feed stream 308 (or, if no pre-treatment is done, then gaseous feed stream 301), is referred to as gaseous reaction stream 321. Although one first reactor 320 is shown, system 300(I) may optionally have multiple of first reactor 320. First reactor 320 is optionally a fixed bed reactor. First reactor 320 is optionally a fluidized bed reactor.

Optionally, first reactor 320 comprises 35 wt. % or less of liquid water by weight of the sorbent composition and the liquid water and/or gaseous reaction stream 321 has 35 wt. % or less of condensed water by weight of the gaseous reaction stream immediately prior to entering the first reactor or immediately prior to initial contact with the sorbent composition upon entering the first reactor. Applicant notes that having an upper limit of liquid water in first reactor 320 and upper limit of condensed water in gaseous reaction stream 321 is an important condition due to the contemplation that some metal carbonate materials are significantly soluble in water (e.g., K₂CO₃) and/or metal bicarbonate products thereof, as well as some additives, if used in the sorbent composition 322, may also be soluble in water. As such, it is contemplated that having a low or trace amount of condensed water, or even the absence thereof, in the reactor and gaseous reaction stream is generally preferable to minimize loss of sorbent composition (or, spent-sorbent composition) and/or minimize capital and/or operating costs of the subsequent spent-sorbent regeneration subsystem. Optionally, in some aspects, a spent-sorbent regeneration subsystem is optional or absent or not always utilized, depending on amount or rate of sorbent and/or spent-sorbent composition loss from first reactor 320. Optionally, in some aspects, first reactor 320 comprises a heat exchanger 381, such as a heater, configured to maintain the temperature of gaseous reaction stream 321 above its dew point to avoid or minimize condensation of water vapor from gaseous reaction stream 321.

Reaction (FX2) among sorbent composition 322, or metal carbonate material (e.g., CaCO₃) thereof, CO₂ gas, and H₂O vapor takes places throughout first reactor 320 as gaseous reaction stream 321 flows through first reactor 320 and comes in contact with sorbent composition 322. The reaction (FX2) produces a spent-sorbent composition 323 having a metal bicarbonate material.

In some aspects first reactor 320 is a fluidized bed reactor. In some aspects, such as but not necessarily wherein first reactor 320 is a fluidized bed reactor, gaseous feed stream 321 fluidizes sorbent composition 322, which comprises a metal carbonate material, optionally in the form of solid particulates or granules, which optionally further comprises one or more additives. In some aspects, such as but not necessarily wherein first reactor 320 is a fluidized bed reactor, fluidization of sorbent composition 322 by gaseous reaction stream 321 causes abrasion forces that decrease the particulate size of the solids in reactor 320, thereby forming fine particulates(e.g., dust) 323a of spent-sorbent composition 323. At least a portion of the fine particulates 323a of spent-sorbent composition 323 are carried or aerosolized by the gaseous reaction stream 321. A first gaseous output stream 324 exits reaction 320, the first gaseous output stream 324 having a reduced concentration of CO₂ than the gaseous reaction stream immediately prior to its initial contact with sorbent composition. Optionally, in some aspects, first gaseous output stream 324 comprises other gaseous species or aerosolized or suspended species, such as H₂O and/or impurity species. Optionally, in some aspects, such as but not necessarily wherein first reactor 320 is a fluidized bed reactor, first gaseous output stream 324 comprises fine particulates of spent-sorbent composition (e.g., as dust) 323a. Optionally, in some aspects, first gaseous output stream 324 is provided to a spent-sorbent collection/separation subsystem 330 which comprises a first separation device 331, which is optionally a cyclone, in some aspects. Optionally, in some aspects, such as but not necessarily wherein first reactor 320 is a fluidized bed reactor, first separation device 331 separates first gaseous output stream 324 into a second gaseous output stream 325 and a solid stream 326, solid stream 326 having spent-sorbent composition 323 (e.g., at least a portion of 323a). In some aspects, solid stream 326 is provided to a second reactor 341, optionally referred to as a regenerator, of sorbent-regeneration subsystem 340. Although one second reactor 341 is shown, sorbent-regeneration subsystem 340 optionally comprises two or more of second reactor 341. Second reactor 341 has an elevated temperature (e.g., 160° C.±20° C.) sufficient to decompose the metal bicarbonate material (e.g., Ca(HCO₃)₂) from solid stream 326 thereby reforming the metal carbonate material (e.g., CaCO₃) and releasing CO₂ (optionally humid CO₂), in some aspects for example, as third gaseous output stream 342. Optionally, in some aspects for example, the reformed metal carbonate material is removed from second reactor 341 and provided back to first reactor 320 as regenerated-sorbent composition 322(b) in solids stream 343, further optionally with additional processing thereof, such as granulation, or further optionally without additional processing thereof.

In some aspects first reactor 320 is a fixed bed reactor. In some aspects, such as but not necessarily wherein first reactor 320 is a fixed bed reactor, although it is preferred to minimize or avoid having condensed water in first reactor 320, some condensed water may be present or accumulated. In some aspects, such as but not necessarily wherein first reactor 320 is a fixed bed reactor, liquid water in first reactor 320 may suspend and/or dissolve a portion of sorbent composition 322, such as a fraction of metal carbonate material and/or a fraction of one or more additives. In some aspects, such as but not necessarily wherein first reactor 320 is a fixed bed reactor, water having some fraction of sorbent composition suspended therein exits first reactor 320 as a slurry 371. In some aspects, such as but not necessarily wherein first reactor 320 is a fixed bed reactor, slurry 371 is provided to a spent-sorbent collection subsystem 370. Optionally, in some aspects, such as but not necessarily wherein first reactor 320 is a fixed bed reactor, spent-sorbent collection subsystem 370 separates spent-sorbent composition from water of slurry 371. In some aspects, such as but not necessarily wherein first reactor 320 is a fixed bed reactor, slurry 371 or at least a portion of spent-sorbent composition separated therefrom is provided to second reactor 341 of sorbent-regeneration subsystem 340 as spent-sorbent stream 372. Optionally, in some aspects, such as but not necessarily wherein first reactor 320 is a fixed bed reactor, first reactor 320 may itself be used as a second reactor 341 by providing slurry 371 or at least a portion of spent-sorbent composition separated therefrom back to first reactor 320 as spent-sorbent stream 373, and operating first reactor 320 under any conditions described herein with respect to second reactor 341 (wherein, when first reactor 320 is thus operated as a regenerator, it may itself be referred to as second reactor 341 when used to form regenerated-sorbent composition).

Optionally, in some aspects wherein first reactor 320 is a fluidized bed reactor, slurry 371 may form, although not preferable, in which case spent-sorbent collection subsystem 370 may be used as described above. Optionally, in some aspects wherein first reactor 320 is a fixed bed reactor, first gaseous output stream 324 may contain particulates of 323a of spent-sorbent composition, and spent-sorbent separation subsystem 330 may be used as described above.

Third gaseous output stream 342 comprises CO₂ (optionally humid CO₂), which is formed in and released from second reactor 341 as a result of the metal bicarbonate decomposition. Third gaseous output stream 342 optionally, in some aspects, comprises fine solid particulates carried thereby or suspended therein, the fine solid particulates having the reformed metal carbonate, and optionally also some amount of un-decomposed metal bicarbonate. Third gaseous output stream 342 is optionally, in some aspects, provided to a second separation device 332, such as a cyclone, which separates third gaseous output stream 342 into a fourth gaseous output stream 351 and a solids stream 352. Fourth gaseous output stream 351 comprises CO₂ (optionally humid CO₂). Optionally, in some aspects, fourth gaseous output stream 351 further comprises some amount of fine solid particulates (e.g., fine dust) comprising of reformed metal carbonate material and/or un-decomposed metal bicarbonate material from second reactor 341. Solids stream 352 comprises reformed metal carbonate material, and may optionally in some aspects comprise some amount of un-decomposed metal bicarbonate material.

Optionally, in some aspects for example, solids stream 352 is provided back to second reactor 341 in order to further decompose any remaining un-decomposed metal bicarbonate. Solids stream 343 may therefore comprise material having arrived from solids stream 352. Optionally, in some aspects for example, solids stream 352 is provided back to first reactor 320 as regenerated-sorbent composition 322(c), further optionally with additional processing thereof, such as granulation, or further optionally without additional processing thereof.

Optionally, in some aspects for example, fourth gaseous output stream 351 is provided to a third separation device 333, such as a cyclone. Third separation device 333 separates fourth gaseous output stream 351 into a fifth gaseous output stream 353 and a solids stream 354. Solids stream 354 comprises the reformed metal carbonate material. Optionally, in some aspects for example, solids stream 354 further comprises some amount of un-decomposed metal bicarbonate material. Optionally, in some aspects for example, solids stream 354 is provided back to first reactor 320 as regenerated-sorbent composition 322(c), further optionally with additional processing thereof, such as granulation, or further optionally without additional processing thereof. Optionally, in some aspects for example, solids stream 354 is further processed to increase particular size, such as by providing solids stream 354 to a solids-processing device 345, which is optionally a granulator and/or spheronizer. Solids-processing device 345 produces a solids stream 356, characterized by an average particulate size greater than that in solids stream 354, optionally greater than in solids stream 352, optionally greater than in solids stream 326. Optionally, in some aspects for example, solids stream 356 is provided back to first reactor 320 as regenerated-sorbent composition 322(d), further optionally with additional processing thereof or further optionally without additional processing thereof. Optionally, in some aspects for example, solids stream 356 provided back to second reactor 341, wherein any un-decomposed metal bicarbonate material may be further decomposed to metal carbonate. Solids stream 343 may therefore optionally comprise some amount of material from solids stream 356.

Optionally, in some aspects for example, separation devices 331, 332, and 333, if used, can be one, two, three, or more separation devices. Optionally, in some aspects for example, any of the separation devices may optionally be used to receive, and separate, any one or more of the aforementioned gaseous streams. For example, separation device 331 may be used to receive stream 342 instead of separation device 332. For example, separation device 332 may be used to receive stream 324 instead of separation device 331.

Optionally, in some aspects for example, fifth gaseous output stream 353 is a product stream of system 300(I). Optionally, in some aspects for example, fifth gaseous output stream 353 is further processed, such as via a de-humidification device 360 to remove or reduce water vapor from fifth gaseous output stream 353. Optionally, in some aspects for example, fifth gaseous output stream 353, or the dehumidified CO₂ gas stream 354 thereof, is concentrated, liquefied, and/or stored or sequestered.

Optionally, in some aspects for example, some amount of liquid water is present in first reactor 320, resulting in formation of a slurry 326 comprising spent-sorbent composition 323 (dissolved, dispersed, and/or suspended in water), optionally also sorbent composition 322 (dissolved, dispersed, and/or suspended in water). Optionally, in some aspects for example, slurry 326 is processed to separate out and/or precipitate solid particulates, forming solids stream 327. Optionally, in some aspects for example, solids stream 326 or solids stream 327 is provided to sorbent-regeneration subsystem 340 in order to decompose metal bicarbonate material therein and regenerate sorbent composition 322. Optionally, in some aspects for example, solids stream 326 or solids stream 327 is provided to second reactor 341. Optionally, in some aspects for example, solids stream 326 or solids stream 327 is provided to a different regenerator reactor (or, third reactor 346) of sorbent-regeneration subsystem 340, third reactor 346 likewise having an elevated temperature sufficient to decompose metal bicarbonate material into metal carbonate material.

### REFERENCES CORRESPONDING TO ABOVE DETAILED DESCRIPTION

1. Rodriguez-Mosqueda, R.; Bramer, E. A.; Roestenberg, T.; Brem, G., Parametrical Study on CO2 Capture from Ambient Air Using Hydrated K2CO3 Supported on an Activated Carbon Honeycomb. Industrial & Engineering Chemistry Research 2018, 57 (10), 3628-3638.
2. Veselovskaya, J. V.; Derevschikov, V. S.; Kardash, T. Y.; Stonkus, O. A.; Trubitsina, T. A.; Okunev, A. G., Direct CO2 capture from ambient air using K2CO3/Al2O3 composite sorbent. International Journal of Greenhouse Gas Control 2013, 17, 332-340.
3. Derevschikov, V. S.; Veselovskaya, J. V.; Kardash, T. Y.; Trubitsyn, D. A.; Okunev, A. G., Direct CO2 capture from ambient air using K2CO3/Y2O3 composite sorbent. Fuel 2014, 127, 212-218.
4. Yi, C.-K.; Jo, S.-H.; Seo, Y.; Lee, J.-B.; Ryu, C.-K., Continuous operation of the potassium-based dry sorbent CO2 capture process with two fluidized-bed reactors. International Journal of Greenhouse Gas Control 2007, 1 (1), 31-36.
5. Park, Y. C.; Jo, S.-H.; Ryu, C. K.; Yi, C.-K., Long-term operation of carbon dioxide capture system from a real coal-fired flue gas using dry regenerable potassium-based sorbents. Energy Procedia 2009, 1 (1), 1235-1239.
6. Hwang, K.-S.; Park, S.-W.; Park, D.-W.; Oh, K.-J.; Kim, S.-S., Sorption kinetics of carbon dioxide onto rubidium carbonate. Korean Journal of Chemical Engineering 2009, 26 (5), 1383-1388.
7. Yi, W.-T.; Yan, C.-Y.; Ma, P.-H., Kinetic study on carbonation of crude Li2CO3 with CO2-water solutions in a slurry bubble column reactor. Korean Journal of Chemical Engineering 2011, 28 (3), 703-709.
8. Park, S.-W.; Sung, D.-H.; Choi, B.-S.; Lee, J.-W.; Kumazawa, H., Carbonation kinetics of potassium carbonate by carbon dioxide. Journal of industrial and engineering chemistry 2006, 12 (4), 522-530.
9. Park, S. W.; Sung, D. H.; Choi, B. S.; Oh, K. J.; Moon, K. H., Sorption of Carbon Dioxide onto Sodium Carbonate. Separation Science and Technology 2006, 41 (12), 2665-2684.
10. Cai, T.; Chen, X.; Tang, H.; Zhou, W.; Wu, Y.; Zhao, C., Unraveling the disparity of CO2 sorption on alkali carbonates under high humidity. Journal of CO2 Utilization 2021, 53, 101737.
11. Hartman, M.; Svoboda, K.; Ĉech, B.; Poho\textcircled{r}elý, M.; Ŝyc, M., Decomposition of Potassium Hydrogen Carbonate: Thermochemistry, Kinetics, and Textural Changes in Solids. Industrial & Engineering Chemistry Research 2019, 58 (8), 2868-2881.
12. Liu, J.; Gong, X.; Zhang, W.; Sun, F.; Wang, Q., Experimental Study on a Flue Gas Waste Heat Cascade Recovery System under Variable Working Conditions. Energies 2020, 13 (2).

Certain Aspects And Embodiments:

Various aspects are contemplated herein, several of which are set forth in the paragraphs below. It is explicitly contemplated that any aspect or portion thereof can be combined to form an aspect. In addition, it is explicitly contemplated that: any reference to aspect 1 includes reference to aspects 1a, 1b, 1c, and/or 1d, any reference to aspect 5 includes reference to aspects 5a and 5b, and so on (any reference to an aspect includes reference to that aspects lettered versions). Moreover, the terms “any preceding aspect” and “any one of the preceding aspects” means any aspect that appears prior to the aspect that contains such phrase (in other words, the sentence “Aspect 32: The method or system of any preceding aspect . . . ” means that any aspect prior to aspect 32 is referenced, including aspects 1a through 31). For example, it is contemplated that, optionally, any system or method of any the below aspects may be useful with or combined with any other aspect provided below. Further, for example, it is contemplated that any embodiment described above may, optionally, be combined with any of the below listed aspects.

Aspect 1a: A system for capturing CO₂ gas, the system comprising:
a gaseous feed stream having an initial concentration of the CO₂ gas;
   wherein the gaseous feed stream is directly or indirectly provided to a first reactor as a gaseous reaction stream;
the first reactor comprising a sorbent composition and the gaseous reaction stream flowing therein, the gaseous reaction stream being in contact with the sorbent composition; and
a first gaseous output stream that exists the first reactor, the first gaseous output stream having a concentration of CO₂ being less than the initial concentration of CO₂ in the gaseous feed stream;
wherein:
   the gaseous reaction stream comprises the CO₂ gas and is characterized by a relative humidity of at least 1% (optionally at least 4%, optionally at least 5%, optionally at least 6%, optionally at least 8%, optionally at least 10%, optionally at least 15%, optionally at least 20%, optionally at least 25%, optionally at least 30%, optionally at least 35%, optionally at least 40%; optionally at least 45%, optionally at least 50%, optionally at least 55%, optionally at least 70%, optionally at least 80%, optionally at least 85%, optionally at least 90%, optionally at least 95%, optionally at least 99%, optionally 100%);
   the sorbent composition comprises at least one metal carbonate material that reacts with the CO₂ gas of the gaseous reaction stream thereby reducing CO₂ gas concentration in the gaseous reaction stream; and
   wherein:
   (a) the first reactor comprises 35 wt. % or less (optionally less than 35 wt. %, optionally less than or equal to 34 wt. %, optionally less than or equal to 31 wt. %, optionally less than or equal to 30 wt. %, optionally less than or equal to 28 wt. %, optionally less than or equal to 25 wt. %, optionally less than or equal to 20 wt. %, optionally less than or equal to 15 wt. %, optionally less than or equal to 10 wt. %, optionally less than or equal to 5 wt. %, optionally less than or equal to 3 wt. %, optionally less than or equal to 1 wt. %, optionally less than 1 wt. %) of liquid water by weight of the sorbent composition and the liquid water (e.g., during operation of the first reactor for CO₂ capture and/or during steady state operation of the first reactor for CO₂ capture); and/or
   (b) the gaseous reaction stream has 35 wt. % or less (optionally less than 35 wt. %, optionally less than or equal to 34 wt. %, optionally less than or equal to 31 wt. %, optionally less than or equal to 30 wt. %, optionally less than or equal to 28 wt. %, optionally less than or equal to 25 wt. %, optionally less than or equal to 20 wt. %, optionally less than or equal to 15 wt. %, optionally less than or equal to 10 wt. %, optionally less than or equal to 5 wt. %, optionally less than or equal to 3 wt. %, optionally less than or equal to 1 wt. %, optionally less than 1 wt. %) of condensed water by weight of the gaseous reaction stream immediately prior to entering the first reactor or immediately prior to initial contact with the sorbent composition upon entering the first reactor (e.g., during operation of the first reactor for CO₂ capture and/or during steady state operation of the first reactor for CO₂ capture).

Aspect 1b: A system for capturing CO₂ gas, the system comprising:
a gaseous feed stream having an initial concentration of the CO₂ gas;
   wherein the gaseous feed stream is directly or indirectly provided to a first reactor as a gaseous reaction stream;
the first reactor comprising a sorbent composition and the gaseous reaction stream flowing therein, the gaseous reaction stream being in contact with the sorbent composition; and
a first gaseous output stream that exists the first reactor, the first gaseous output stream having a concentration of CO₂ being less than the initial concentration of CO₂ in the gaseous feed stream;
wherein:
   the gaseous reaction stream comprises the CO₂ gas and is characterized by a relative humidity of at least 1% (optionally at least 4%, optionally at least 5%, optionally at least 6%, optionally at least 8%, optionally at least 10%, optionally at least 15%, optionally at least 20%, optionally at least 25%, optionally at least 30%, optionally at least 35%, optionally at least 40%; optionally at least 45%, optionally at least 50%, optionally at least 55%, optionally at least 70%, optionally at least 80%, optionally at least 85%, optionally at least 90%, optionally at least 95%, optionally at least 99%, optionally 100%);
   the sorbent composition comprises at least one metal carbonate material that reacts with the CO₂ gas of the gaseous reaction stream thereby reducing CO₂ gas concentration in the gaseous reaction stream; and
   the sorbent composition further comprises one or more additives.

Aspect 1c: A system for capturing CO₂ gas, the system comprising:
a gaseous feed stream having an initial concentration of the CO₂ gas;
   wherein the gaseous feed stream is directly or indirectly provided to a first reactor as a gaseous reaction stream;
the first reactor comprising a sorbent composition and the gaseous reaction stream flowing therein, the gaseous reaction stream being in contact with the sorbent composition;
a first gaseous output stream that exists the first reactor, the first gaseous output stream having a concentration of CO₂ being less than the initial concentration of CO₂ in the gaseous feed stream; and
a sorbent-regeneration subsystem;
wherein:
   the gaseous reaction stream comprises the CO₂ gas and is characterized by a relative humidity of at least 1% (optionally at least 4%, optionally at least 5%, optionally at least 6%, optionally at least 8%, optionally at least 10%, optionally at least 15%, optionally at least 20%, optionally at least 25%, optionally at least 30%, optionally at least 35%, optionally at least 40%; optionally at least 45%, optionally at least 50%, optionally at least 55%, optionally at least 70%, optionally at least 80%, optionally at least 85%, optionally at least 90%, optionally at least 95%, optionally at least 99%, optionally 100%);
   the sorbent composition comprises a metal carbonate material that reacts with the CO₂ gas of the gaseous reaction stream thereby reducing CO₂ gas concentration in the gaseous reaction stream;
   a spent-sorbent composition from the first reactor is provided to a sorbent-regeneration subsystem;
   the spent-sorbent composition comprises a metal bicarbonate material formed in the first reactor as a result of the reaction of the metal carbonate material with the CO₂ gas;
   the sorbent-regeneration subsystem converts the provided spent-sorbent composition to a regenerated-sorbent composition; and
   the regenerated-sorbent composition is recycled back to the first reactor.

Aspect 1d: A method for capturing CO₂ gas, the method comprising:
feeding, directly or indirectly, a gaseous feed stream having an initial concentration of the CO₂ gas to a first reactor as a gaseous reaction stream;
   wherein the first reactor comprises a sorbent composition and the gaseous reaction stream flowing therein, the gaseous reaction stream being in contact with the sorbent composition;
   wherein the gaseous reaction stream comprises the CO₂ gas and is characterized by a relative humidity of at least 1% (optionally at least 4%, optionally at least 5%, optionally at least 6%, optionally at least 8%, optionally at least 10%, optionally at least 15%, optionally at least 20%, optionally at least 25%, optionally at least 30%, optionally at least 35%, optionally at least 40%; optionally at least 45%, optionally at least 50%, optionally at least 55%, optionally at least 70%, optionally at least 80%, optionally at least 85%, optionally at least 90%, optionally at least 95%, optionally at least 99%, optionally 100%); and
   wherein the sorbent composition comprises a metal carbonate material; and
reacting the CO₂ gas in the gaseous reactions stream with the metal carbonate material thereby reducing CO₂ gas concentration in the gaseous reaction stream;
   wherein a first gaseous output stream exists the first reactor, the first gaseous output stream having a concentration of CO₂ being less than the initial concentration of CO₂ in the gaseous feed stream; and
   wherein:
   (a) the first reactor comprises 35 wt. % or less (optionally less than 35 wt. %, optionally less than or equal to 34 wt. %, optionally less than or equal to 31 wt. %, optionally less than or equal to 30 wt. %, optionally less than or equal to 28 wt. %, optionally less than or equal to 25 wt. %, optionally less than or equal to 20 wt. %, optionally less than or equal to 15 wt. %, optionally less than or equal to 10 wt. %, optionally less than or equal to 5 wt. %, optionally less than or equal to 3 wt. %, optionally less than or equal to 1 wt. %, optionally less than 1 wt. %) of liquid water by weight of the sorbent composition and the liquid water (e.g., during operation of the first reactor for CO₂ capture and/or during steady state operation of the first reactor for CO₂ capture); and/or
   (b) the gaseous reaction stream has 35 wt. % or less (optionally less than 35 wt. %, optionally less than or equal to 34 wt. %, optionally less than or equal to 31 wt. %, optionally less than or equal to 30 wt. %, optionally less than or equal to 28 wt. %, optionally less than or equal to 25 wt. %, optionally less than or equal to 20 wt. %, optionally less than or equal to 15 wt. %, optionally less than or equal to 10 wt. %, optionally less than or equal to 5 wt. %, optionally less than or equal to 3 wt. %, optionally less than or equal to 1 wt. %, optionally less than 1 wt. %) of condensed water by weight of the gaseous reaction stream immediately prior to entering the first reactor or immediately prior to initial contact with the sorbent composition upon entering the first reactor (e.g., during operation of the first reactor for CO₂ capture and/or during steady state operation of the first reactor for CO₂ capture).

Aspect 1e: A method for capturing CO₂ gas, the method comprising:
feeding, directly or indirectly, a gaseous feed stream having an initial concentration of the CO₂ gas to a first reactor as a gaseous reaction stream;
   wherein the first reactor comprises an sorbent composition and the gaseous reaction stream flowing therein, the gaseous reaction stream being in contact with the sorbent composition;
   wherein the gaseous reaction stream comprises the CO₂ gas and is characterized by a relative humidity of at least 5%; and
   wherein the sorbent composition comprises at least one metal carbonate material and one or more additives; and
reacting the CO₂ gas in the gaseous reactions stream with the at least one metal carbonate material thereby reducing CO₂ gas concentration in the gaseous reaction stream;
   wherein a first gaseous output stream exists the first reactor, the first gaseous output stream having a concentration of CO₂ being less than the initial concentration of CO₂ in the gaseous feed stream.

Aspect 1f: A method for capturing CO₂ gas, the method comprising:
feeding, directly or indirectly, a gaseous feed stream having an initial concentration of the CO₂ gas to a first reactor as a gaseous reaction stream;
   wherein the first reactor comprises a sorbent composition and the gaseous reaction stream flowing therein, the gaseous reaction stream being in contact with the sorbent composition;
   wherein the gaseous reaction stream comprises the CO₂ gas and is characterized by a relative humidity of at least 1% (optionally at least 4%, optionally at least 5%, optionally at least 6%, optionally at least 8%, optionally at least 10%, optionally at least 15%, optionally at least 20%, optionally at least 25%, optionally at least 30%, optionally at least 35%, optionally at least 40%; optionally at least 45%, optionally at least 50%, optionally at least 55%, optionally at least 70%, optionally at least 80%, optionally at least 85%, optionally at least 90%, optionally at least 95%, optionally at least 99%, optionally 100%); and
   wherein the sorbent composition comprises a metal carbonate material;
reacting the CO₂ gas in the gaseous reactions stream with the metal carbonate material thereby reducing CO₂ gas concentration in the gaseous reaction stream;
   wherein a first gaseous output stream exists the first reactor, the first gaseous output stream having a concentration of CO₂ being less than the initial concentration of CO₂ in the gaseous feed stream; and
   wherein a spent-sorbent composition comprising a metal bicarbonate material is formed in the first reactor as a result of the reaction of the metal carbonate material with the CO₂ gas;
regenerating the sorbent composition via a sorbent-regeneration subsystem by converting the provided spent-sorbent composition to a regenerated-sorbent composition; and
recycling the regenerated-sorbent composition back to the first reactor.

Aspect 1g: A system for capturing CO₂ gas, the system comprising:
a gaseous feed stream having an initial concentration of the CO₂ gas;
   wherein the gaseous feed stream is directly or indirectly provided to a first reactor as a gaseous reaction stream;
the first reactor comprising a sorbent composition and the gaseous reaction stream flowing therein, the gaseous reaction stream being in contact with the sorbent composition; and
a first gaseous output stream that exists the first reactor, the first gaseous output stream having a concentration of CO₂ being less than the initial concentration of CO₂ in the gaseous feed stream;
wherein:
   the gaseous reaction stream comprises the CO₂ gas and is characterized by a relative humidity of at least 1% (optionally at least 4%, optionally at least 5%, optionally at least 6%, optionally at least 8%, optionally at least 10%, optionally at least 15%, optionally at least 20%, optionally at least 25%, optionally at least 30%, optionally at least 35%, optionally at least 40%; optionally at least 45%, optionally at least 50%, optionally at least 55%, optionally at least 70%, optionally at least 80%, optionally at least 85%, optionally at least 90%, optionally at least 95%, optionally at least 99%, optionally 100%);
   the sorbent composition comprises at least one metal carbonate material that reacts with the CO₂ gas of the gaseous reaction stream thereby reducing CO₂ gas concentration in the gaseous reaction stream; and
   wherein:
   (a) the first reactor comprises 35 wt. % or less (optionally less than 35 wt. %, optionally less than or equal to 34 wt. %, optionally less than or equal to 31 wt. %, optionally less than or equal to 30 wt. %, optionally less than or equal to 28 wt. %, optionally less than or equal to 25 wt. %, optionally less than or equal to 20 wt. %, optionally less than or equal to 15 wt. %, optionally less than or equal to 10 wt. %, optionally less than or equal to 5 wt. %, optionally less than or equal to 3 wt. %, optionally less than or equal to 1 wt. %, optionally less than 1 wt. %) of liquid water by weight of the sorbent composition and the liquid water (e.g., during operation of the first reactor for CO₂ capture and/or during steady state operation of the first reactor for CO₂ capture); and/or
   (b) the gaseous reaction stream has 95 wt. % or less (optionally 90 wt. % or less, optionally 85 wt. % or less, optionally 80 wt. % or less, optionally 75 wt. % or less, optionally 70 wt. % or less, optionally 65 wt. % or less, optionally 60 wt. % or less, optionally 55 wt. %, optionally less than 50 wt. % or less, optionally 45 wt. % or less, optionally 40 wt. % or less, optionally 35 wt. % or less, optionally less than 35 wt. %, optionally less than or equal to 34 wt. %, optionally less than or equal to 31 wt. %, optionally less than or equal to 30 wt. %, optionally less than or equal to 28 wt. %, optionally less than or equal to 25 wt. %, optionally less than or equal to 20 wt. %, optionally less than or equal to 15 wt. %, optionally less than or equal to 10 wt. %, optionally less than or equal to 5 wt. %, optionally less than or equal to 3 wt. %, optionally less than or equal to 1 wt. %, optionally less than 1 wt. %) of condensed water by weight of the gaseous reaction stream immediately prior to entering the first reactor or immediately prior to initial contact with the sorbent composition upon entering the first reactor (e.g., during operation of the first reactor for CO₂ capture and/or during steady state operation of the first reactor for CO₂ capture).

Aspect 1h: A method for capturing CO₂ gas, the method comprising:
feeding, directly or indirectly, a gaseous feed stream having an initial concentration of the CO₂ gas to a first reactor as a gaseous reaction stream;
   wherein the first reactor comprises a sorbent composition and the gaseous reaction stream flowing therein, the gaseous reaction stream being in contact with the sorbent composition;
   wherein the gaseous reaction stream comprises the CO₂ gas and is characterized by a relative humidity of at least 1% (optionally at least 4%, optionally at least 5%, optionally at least 6%, optionally at least 8%, optionally at least 10%, optionally at least 15%, optionally at least 20%, optionally at least 25%, optionally at least 30%, optionally at least 35%, optionally at least 40%; optionally at least 45%, optionally at least 50%, optionally at least 55%, optionally at least 70%, optionally at least 80%, optionally at least 85%, optionally at least 90%, optionally at least 95%, optionally at least 99%, optionally 100%); and
   wherein the sorbent composition comprises a metal carbonate material; and
reacting the CO₂ gas in the gaseous reactions stream with the metal carbonate material thereby reducing CO₂ gas concentration in the gaseous reaction stream;
   wherein a first gaseous output stream exists the first reactor, the first gaseous output stream having a concentration of CO₂ being less than the initial concentration of CO₂ in the gaseous feed stream; and
   wherein:
   (a) the first reactor comprises 35 wt. % or less (optionally less than 35 wt. %, optionally less than or equal to 34 wt. %, optionally less than or equal to 31 wt. %, optionally less than or equal to 30 wt. %, optionally less than or equal to 28 wt. %, optionally less than or equal to 25 wt. %, optionally less than or equal to 20 wt. %, optionally less than or equal to 15 wt. %, optionally less than or equal to 10 wt. %, optionally less than or equal to 5 wt. %, optionally less than or equal to 3 wt. %, optionally less than or equal to 1 wt. %, optionally less than 1 wt. %) of liquid water by weight of the sorbent composition and the liquid water (e.g., during operation of the first reactor for CO₂ capture and/or during steady state operation of the first reactor for CO₂ capture); and/or
   (b) the gaseous reaction stream has 95 wt. % or less (optionally 90 wt. % or less, optionally 85 wt. % or less, optionally 80 wt. % or less, optionally 75 wt. % or less, optionally 70 wt. % or less, optionally 65 wt. % or less, optionally 60 wt. % or less, optionally 55 wt. %, optionally less than 50 wt. % or less, optionally 45 wt. % or less, optionally 40 wt. % or less, optionally 35 wt. % or less, optionally less than 35 wt. %, optionally less than or equal to 34 wt. %, optionally less than or equal to 31 wt. %, optionally less than or equal to 30 wt. %, optionally less than or equal to 28 wt. %, optionally less than or equal to 25 wt. %, optionally less than or equal to 20 wt. %, optionally less than or equal to 15 wt. %, optionally less than or equal to 10 wt. %, optionally less than or equal to 5 wt. %, optionally less than or equal to 3 wt. %, optionally less than or equal to 1 wt. %, optionally less than 1 wt. %) of condensed water by weight of the gaseous reaction stream immediately prior to entering the first reactor or immediately prior to initial contact with the sorbent composition upon entering the first reactor (e.g., during operation of the first reactor for CO₂ capture and/or during steady state operation of the first reactor for CO₂ capture).

Aspect 2a: The method or system of any preceding Aspect, wherein the first reactor comprises 5 wt. % or less of liquid water by weight of sorbent composition and liquid water. Aspect 2b: The method or system of any preceding Aspect, wherein the first reactor comprises 5 wt. % or less of liquid water by weight of sorbent composition and liquid water during operation of the first reactor for CO₂ capture and/or during steady state operation of the first reactor for CO₂ capture.

Aspect 3a: The method or system of any preceding Aspect, wherein the gaseous reaction stream has 5 wt. % or less of condensed water by weight of the gaseous reaction stream immediately prior to entering the first reactor or immediately prior to initial contact with the sorbent composition upon entering the first reactor. Aspect 3b: The method or system of any preceding Aspect, wherein the gaseous reaction stream has 5 wt. % or less of condensed water by weight of the gaseous reaction stream immediately prior to entering the first reactor or immediately prior to initial contact with the sorbent composition upon entering the first reactor during operation of the first reactor for CO₂ capture and/or during steady state operation of the first reactor for CO₂ capture. Aspect 3c: The method or system of any preceding Aspect, wherein if no individual component of the sorbent composition (e.g., among the at least one metal carbonate material, the at least one additive, and the at least one support material, if present) is both water-soluble and is present in the sorbent composition at 1 wt. % or more, then the gaseous reaction stream has 35 wt. % or less (optionally less than 35 wt. %, optionally less than or equal to 34 wt. %, optionally less than or equal to 31 wt. %, optionally less than or equal to 30 wt. %, optionally less than or equal to 28 wt. %, optionally less than or equal to 25 wt. %, optionally less than or equal to 20 wt. %, optionally less than or equal to 15 wt. %, optionally less than or equal to 10 wt. %, optionally less than or equal to 5 wt. %, optionally less than or equal to 3 wt. %, optionally less than or equal to 1 wt. %, optionally less than 1 wt. %) of condensed water by weight of the gaseous reaction stream immediately prior to entering the first reactor or immediately prior to initial contact with the sorbent composition upon entering the first reactor, optionally during operation of the first reactor for CO₂ capture and/or during steady state operation of the first reactor for CO₂ capture.

Aspect 4: The method or system of any preceding Aspect, wherein the sorbent composition further comprises one or more additives; and wherein the one or more additives comprise one or more binders, one or more pore expanders, one or more cross-linkers, one or more lubricants, one or more extrusion aids, or any combination thereof.

Aspect 5a: The method or system of Aspect 4, wherein at least one of the one or more additives is a synthetic organic compound. Aspect 5b: The method or system of Aspect 4, wherein at least one of the one or more additives is not an inorganic mineral. Aspect 5c: The method or system of Aspect 4, wherein at least one of the one or more additives is a synthetic organic compound and/or is not an inorganic mineral.

Aspect 5: The method or system of any preceding Aspect, wherein the sorbent-regeneration subsystem comprises granulation such that the regenerated-sorbent composition has a larger particulate size than the spent-sorbent composition.

Aspect 6: The method or system of any preceding Aspect, wherein a spent-sorbent composition from the first reactor is provided to a sorbent-regeneration subsystem; wherein the spent-sorbent composition comprises a metal bicarbonate material formed in the first reactor as a result of the reaction of the metal carbonate material with the CO₂ gas; wherein the sorbent-regeneration subsystem converts the provided spent-sorbent composition to a regenerated-sorbent composition; and wherein the regenerated-sorbent composition is recycled back to the first reactor.

Aspect 7: The method or system of any preceding Aspect, wherein the sorbent-regeneration subsystem decomposes the metal bicarbonate material to reform the at least one metal carbonate material.

Aspect 8: The method or system of Aspect 7, wherein the sorbent-regeneration subsystem granulates the reformed metal carbon material to increase particulate size and make the regenerated-sorbent composition having a larger particulate size than the spent-sorbent composition.

Aspect 9: The method or system of Aspect 8, wherein spheronization is further performed to make the regenerated-sorbent composition.

Aspect 10: The method or system of any preceding Aspect, wherein the sorbent-regeneration subsystem comprises a second reactor in which the metal bicarbonate is decomposed at an absolute pressure selected from the range of greater than 0 bar absolute (bara) (optionally greater than or equal to 0.01 bara, optionally greater than or equal to 0.05 bara, optionally greater than or equal to 0.1 bara, optionally greater than or equal to 0.2 bara, optionally greater than or equal to 0.3 bara, optionally greater than or equal to 0.5 bara) to less than or equal to 20 bar absolute (bara) (optionally less than or equal to 15 bara, optionally less than or equal to 10 bara, optionally less than or equal to 5 bara, optionally less than or equal to 3 bara, optionally less than or equal to 2 bara, optionally less than or equal to 1.5 bara, optionally less than or equal to 1 bara).

Aspect 11a: The method or system of any preceding Aspect, wherein the sorbent-regeneration subsystem comprises a second reactor in which the metal bicarbonate is decomposed at a temperature selected from the range of 20 C to 200 C.

Aspect 11b: The method or system of any preceding Aspect, wherein the sorbent-regeneration subsystem comprises a second reactor in which the metal bicarbonate is decomposed at a temperature greater than or equal to 20 C (optionally greater than or equal to 30 C, optionally greater than or equal to 40 C, optionally greater than or equal to 50 C, optionally greater than or equal to 60 C, optionally greater than or equal to 70 C, optionally greater than or equal to 80 C, optionally greater than or equal to 90 C, optionally greater than or equal to 100 C, optionally greater than or equal to 110 C, optionally greater than or equal to 120 C, optionally greater than or equal to 130 C, optionally greater than or equal to 140 C, optionally greater than or equal to 150 C, optionally greater than or equal to 160 C, optionally greater than or equal to 170 C, optionally greater than or equal to 180 C) and less than or equal to 200 C (optionally less than or equal to 190 C, optionally less than or equal to 180 C, optionally less than or equal to 170 C).

Aspect 12: The method or system of any preceding Aspect, wherein the sorbent-regeneration subsystem comprises a second reactor in which the metal bicarbonate material (of the spent-sorbent composition) is decomposed at a pressure that is less than the pressure at which the at least one metal carbonate material reacts in the first reactor (e.g., of the gaseous reaction stream in the first reactor).

Aspect 13: The method or system of any preceding Aspect, wherein the sorbent-regeneration subsystem further generates a product gaseous stream having CO₂ gas.

Aspect 14: The method or system of any preceding Aspect comprising a spent-sorbent collection subsystem configured to collect the spent-sorbent composition from the first reactor and transfer the collected spent-sorbent composition to the sorbent-regeneration subsystem.

Aspect 15: The method or system of Aspect 14, wherein the metal bicarbonate collection subsystem separates metal bicarbonate from the gaseous reaction stream or from the first gaseous output stream via gravity, one or more cyclones, one or more filters, one or more electrostatic separators, or any combination of these.

Aspect 16: The method or system of any preceding Aspect, wherein the sorbent-regeneration subsystem decomposes the metal bicarbonate, regenerates one or more of the at least one metal carbonate material, and generates CO₂ gas according to formula FX3:

Mₓ(HCO₃)₂(s)→MₓCO₃(s)+CO₂(g)+H₂O(g) (FX3); wherein:

x is 1 or 2.

Aspect 17: The method or system of Aspect 16, wherein the generated CO₂ gas is concentrated, liquefied, and/or stored.

Aspect 18: The method or system of any preceding Aspect, wherein the sorbent-regeneration subsystem comprises a granulator and spheronizer for making the regenerated-sorbent composition.

Aspect 19: The method or system of any preceding Aspect, wherein the regenerated-sorbent composition comprises one or more of the at least one metal carbonate material and is characterized by an average particulate size being within 20% of the average particulate size of the sorbent composition prior to regeneration.

Aspect 20: The method or system of any preceding Aspect, wherein the regenerated-sorbent composition has an average particulate size selected from the range of 30 μm to 1 cm.

Aspect 21a: The method or system of any preceding Aspect, wherein the spent-sorbent composition is characterized by an average particulate size being approximately equal to or less than the average particulate size of the sorbent composition and approximately equal to or less than the average particulate size of the regenerated-sorbent composition, optionally in the case of the first reactor being a fluidized bed reactor. Aspect 21b: The method or system of any preceding Aspect, wherein the spent-sorbent composition is characterized by an average particulate size being less than the average particulate size of the sorbent composition and less than the average particulate size of the regenerated-sorbent composition, optionally in the case of the first reactor being a fluidized bed reactor. Aspect 21c: The method or system of any preceding Aspect, wherein the spent-sorbent composition is characterized by an average particulate size being approximately equal to or greater than the average particulate size of the sorbent composition and approximately equal to or greater than the average particulate size of the regenerated-sorbent composition, optionally in the case of the first reactor being a fixed bed reactor.

Aspect 22: The method or system of any preceding Aspect, wherein the spent-sorbent composition is characterized by an average particulate size being less than 400 μm.

Aspect 23a: The method or system of any preceding Aspect, wherein the sorbent-regeneration subsystem comprises a mixer, an extruder, a spheronizer and/or granulator, and a dryer to make the regenerated-sorbent composition. Aspect 23b: The method or system of any preceding Aspect, wherein the sorbent-regeneration subsystem comprises a mixer, an extruder and/or a spheronizer and/or granulator, and a dryer to make the regenerated-sorbent composition.

Aspect 24: The method or system of any preceding Aspect, wherein the sorbent-regeneration subsystem comprises adding fresh metal carbonate material and/or fresh additive to make the regenerated-sorbent composition.

Aspect 25: The method or system of any preceding Aspect, wherein the regenerated-sorbent composition is identical to a fresh sorbent composition or a weight percent of each component of the regenerated-sorbent composition is within 90% of the same of the fresh sorbent composition.

Aspect 26: The method or system of any preceding Aspect further comprising a feed pre-treatment subsystem configured to pre-treat the gaseous feed stream thereby forming a pre-treated gaseous stream which is provided to the first reactor; wherein the gaseous reaction stream is the pre-treated gaseous stream that enters the first reactor.

Aspect 27: The method or system of Aspect 26, wherein the feed pre-treatment subsystem comprises a water-removal device configured to remove liquid water from the gaseous feed stream immediately prior to its entering the first reactor or immediately prior to initial contact with the sorbent composition in the first reactor.

Aspect 28: The method or system of Aspect 26 or 27, wherein the feed pre-treatment subsystem comprises a humidifier configured to increase the relative humidity of the gaseous feed stream prior to the first reactor, such that the pre-treated gaseous stream has a higher relative humidity than the gaseous feed stream prior to pre-treatment.

Aspect 29: The method or system of any of Aspects 26-28, wherein the feed pre-treatment subsystem comprises a heat-exchanger configured to cool the gaseous feed stream to facilitate removal of liquid water therefrom.

Aspect 30: The method or system of any of Aspects 26-29, wherein the feed pre-treatment subsystem comprises a heat-exchanger configured to heat the gaseous feed stream or pre-treated gaseous stream to a temperature greater than its dew point.

Aspect 31a: The method or system of any of Aspects 26-30, wherein the feed pre-treatment subsystem converts the gaseous feed stream to a pre-treated gaseous stream characterized by a relative humidity of at least 50% and a temperature being at least 0.5° C. greater than the dew point thereof. Aspect 31b: The method or system of any of Aspects 26-30, wherein the feed pre-treatment subsystem converts the gaseous feed stream to a pre-treated gaseous stream characterized by a relative humidity of at least 50% (optionally at least 60%, optionally at least 70%, optionally at least 80%, optionally at least 90%, optionally at least 99%, optionally 100%) and a temperature being at least 0.5° C. greater (optionally at least 0.8° C. greater, optionally at least 1.0° C. greater, optionally at least 1.2° C. greater, optionally at least 1.5° C. greater, optionally at least 2.0° C. greater, optionally at least 2.5° C. greater, optionally at least 3.0° C. greater, optionally at least 3.5° C. greater, optionally at least 4.0° C. greater, optionally at least 5.0° C. greater) than the dew point thereof.

Aspect 32a: The method or system of any preceding Aspect, wherein the first reactor comprises 25 wt. % or less of liquid water by weight of the sorbent composition and liquid water (e.g., during operation of the first reactor for CO₂ capture and/or during steady state operation of the first reactor for CO₂ capture). Aspect 32b: The method or system of any preceding Aspect, wherein the first reactor comprises 20 wt. % or less of liquid water by weight of the sorbent composition and liquid water (e.g., during operation of the first reactor for CO₂ capture and/or during steady state operation of the first reactor for CO₂ capture). Aspect 32c: The method or system of any preceding Aspect, wherein the first reactor comprises 15 wt. % or less of liquid water by weight of the sorbent composition and liquid water (e.g., during operation of the first reactor for CO₂ capture and/or during steady state operation of the first reactor for CO₂ capture).

Aspect 33a: The method or system of any preceding Aspect, wherein the first reactor comprises 10 wt. % or less of liquid water by weight of the sorbent composition and liquid water (e.g., during operation of the first reactor for CO₂ capture and/or during steady state operation of the first reactor for CO₂ capture). Aspect 33b: The method or system of any preceding Aspect, wherein the first reactor comprises 5 wt. % or less of liquid water by weight of the sorbent composition and liquid water (e.g., during operation of the first reactor for CO₂ capture and/or during steady state operation of the first reactor for CO₂ capture).

Aspect 34a: The method or system of any preceding Aspect, wherein the gaseous reaction stream has 25 wt. % or less of condensed water by weight of the gaseous reaction stream immediately prior to entering the first reactor or immediately prior to initial contact with the sorbent composition upon entering the first reactor (e.g., during operation of the first reactor for CO₂ capture and/or during steady state operation of the first reactor for CO₂ capture). Aspect 34b: The method or system of any preceding Aspect, wherein the gaseous reaction stream has 20 wt. % or less of condensed water by weight of the gaseous reaction stream immediately prior to entering the first reactor or immediately prior to initial contact with the sorbent composition upon entering the first reactor (e.g., during operation of the first reactor for CO₂ capture and/or during steady state operation of the first reactor for CO₂ capture). Aspect 34c: The method or system of any preceding Aspect, wherein the gaseous reaction stream has 15 wt. % or less of condensed water by weight of the gaseous reaction stream immediately prior to entering the first reactor or immediately prior to initial contact with the sorbent composition upon entering the first reactor (e.g., during operation of the first reactor for CO₂ capture and/or during steady state operation of the first reactor for CO₂ capture).

Aspect 35a: The method or system of any preceding Aspect, wherein the gaseous reaction stream has 10 wt. % or less of condensed water by weight of the gaseous reaction stream immediately prior to entering the first reactor or immediately prior to initial contact with the sorbent composition upon entering the first reactor (e.g., during operation of the first reactor for CO₂ capture and/or during steady state operation of the first reactor for CO₂ capture). Aspect 35b: The method or system of any preceding Aspect, wherein the gaseous reaction stream has 5 wt. % or less of condensed water by weight of the gaseous reaction stream immediately prior to entering the first reactor or immediately prior to initial contact with the sorbent composition upon entering the first reactor (e.g., during operation of the first reactor for CO₂ capture and/or during steady state operation of the first reactor for CO₂ capture).

Aspect 36: The method or system of any preceding Aspect, wherein each of the at least one metal carbonate material is characterized by formula FX1:

Mₓ(CO₃)_{y} (FX1); wherein:

M is a metal element; and

each of x and y is independently a number.

Aspect 37a: The method or system of Aspect 36, wherein:

M is a Group I or Group II metal element;

x is 1 or 2; and

y is 1.

Aspect 37b: The method or system of Aspect 36, wherein:

M is a Group II metal element;

x is 1; and

y is 1.

Aspect 38a: The method or system of any preceding Aspect, wherein each of the at least one metal carbonate material is K₂CO₃, Na₂CO₃, or CaCO₃. Aspect 38b: The method or system of any preceding Aspect, wherein one or more of the at least one metal carbonate material is K₂CO₃, Na₂CO₃, or CaCO₃.

Aspect 39: The method or system of any preceding Aspect, wherein the sorbent composition is free of a support material for the metal carbonate.

Aspect 40: The method or system of any preceding Aspect except Aspect 39, wherein the sorbent composition comprises one or more support materials for one or more of the at least one metal carbonate material.

Aspect 41: The method or system of Aspect 40, wherein the one or more support materials comprise one or more zeolite materials, an activated carbon material, a ceramic material, or a combination thereof.

Aspect 42a: The method or system of any preceding Aspect, wherein the at least one metal carbonate material is in the form of particulates characterized by an average particulate size selected from the range of 30 nm to 1 cm. Aspect 42b: The method or system of any preceding Aspect, wherein the at least one metal carbonate material is in the form of particulates characterized by an average particulate size greater than or equal to 30 nm (optionally 100 nm, optionally 300 nm, optionally 500 nm, optionally 1 μm, optionally 5 μm, optionally 10 μm, optionally 15 μm, optionally 20 μm, optionally 25 μm, optionally 30 μm, optionally 35 μm, optionally 37 μm, optionally 40 μm, optionally 45 μm, optionally 50 μm, optionally 60 μm, optionally 70 μm, optionally 80 μm, optionally 90 μm, optionally 100 μm, optionally 110 μm, optionally 120 μm, optionally 130 μm, optionally 140 μm, optionally 150 μm, optionally 160 μm, optionally 170 μm, optionally 180 μm, optionally 190 μm, optionally 200 μm, optionally 220 μm, optionally 250 μm, optionally 300 μm, optionally 350 μm, optionally 400 μm, optionally 410 μm, optionally 450 μm,) to less than or equal to 1 cm (optionally 9.5 mm, optionally 9.0 mm, optionally 8.5 mm, optionally 8 mm, optionally 7 mm, optionally 6 mm, optionally 5 mm, optionally 4 mm, optionally 3 mm, optionally 2 mm, optionally 1 mm, optionally 0.5 mm). Aspect 42c: The method or system of any preceding Aspect, wherein the sorbent composition is in the form of particulates characterized by an average particulate size greater than or equal to 30 nm (optionally 100 nm, optionally 300 nm, optionally 500 nm, optionally 1 μm, optionally 5 μm, optionally 10 μm, optionally 15 μm, optionally 20 μm, optionally 25 μm, optionally 30 μm, optionally 35 μm, optionally 37 μm, optionally 40 μm, optionally 45 μm, optionally 50 μm, optionally 60 μm, optionally 70 μm, optionally 80 μm, optionally 90 μm, optionally 100 μm, optionally 110 μm, optionally 120 μm, optionally 130 μm, optionally 140 μm, optionally 150 μm, optionally 160 μm, optionally 170 μm, optionally 180 μm, optionally 190 μm, optionally 200 μm, optionally 220 μm, optionally 250 μm, optionally 300 μm, optionally 350 μm, optionally 400 μm, optionally 410 μm, optionally 450 μm,) to less than or equal to 1 cm (optionally 9.5 mm, optionally 9.0 mm, optionally 8.5 mm, optionally 8 mm, optionally 7 mm, optionally 6 mm, optionally 5 mm, optionally 4 mm, optionally 3 mm, optionally 2 mm, optionally 1 mm, optionally 0.5 mm).

Aspect 43: The method or system of any preceding Aspect, wherein the sorbent composition comprises only one metal carbonate material.

Aspect 44: The method or system of any preceding Aspect except Aspect 43, wherein the sorbent composition comprises at least two metal carbonate materials.

Aspect 45: The method or system of any preceding Aspect, wherein the sorbent composition further comprises one or more additives.

Aspect 46: The method or system of Aspect 45, wherein the one or more additives comprise one or more binders, one or more pore expanders, one or more cross-linkers, one or more lubricants, one or more extrusion aids, or any combination thereof.

Aspect 47: The method or system of any preceding Aspect, wherein the at least one metal carbonate material reacts with the CO₂ gas in the first reactor according to formula FX2:

MₓCO₃(s)+CO₂(g)+H₂O(g)↔*Mₓ(HCO₃)₂(s) (FX2); wherein:

M is a metal element; and

x is 1 or 2.

Aspect 48: The method or system of any preceding Aspect, wherein the gaseous reaction stream is characterized by a temperature being greater than its dew point in the first reactor.

Aspect 49a: The method or system of any preceding Aspect, wherein the gaseous reaction stream is characterized by a temperature being 1° C. to 50° C. greater than its dew point in the first reactor. Aspect 49b: The method or system of any preceding Aspect, wherein the gaseous reaction stream is characterized by a temperature at least 0.5° C. (optionally at least 0.8° C. greater, optionally at least 1.0° C. greater, optionally at least 1.2° C. greater, optionally at least 1.5° C. greater, optionally at least 2.0° C. greater, optionally at least 2.5° C. greater, optionally at least 3.0° C. greater, optionally at least 3.5° C. greater, optionally at least 4.0° C. greater, optionally at least 5.0° C. greater) to at most 50° C. (optionally at most 40° C., optionally at most 30° C., optionally at most 20° C., optionally at most 18° C., optionally at most 15° C., optionally at most 12° C., optionally at most 10° C., optionally at most 8° C., optionally at most 7° C.,) greater than its dew point in the first reactor.

Aspect 50a: The method or system of any preceding Aspect, wherein the gaseous reaction stream is characterized by a temperature selected from the range of 20° C. to 70° C. in the first reactor. Aspect 50b: The method or system of any preceding Aspect, wherein the gaseous reaction stream is characterized by a temperature greater than or equal to 15° C. (optionally greater than or equal to 20 C, optionally greater than or equal to 21 C, optionally greater than or equal to 22 C, optionally greater than or equal to 23 C, optionally greater than or equal to 24 C, optionally greater than or equal to 25 C, optionally greater than or equal to 26 C, optionally greater than or equal to 27 C, optionally greater than or equal to 28 C, optionally greater than or equal to 29 C, optionally greater than or equal to 30 C, optionally greater than or equal to 32 C, optionally greater than or equal to 35 C, optionally greater than or equal to 37 C, optionally greater than or equal to 40 C, optionally greater than or equal to 45 C) and less than or equal to 80 C (optionally less than or equal to 75 C, optionally less than or equal to 70 C, optionally less than or equal to 65 C, optionally less than or equal to 60 C optionally less than or equal to 55 C, optionally less than or equal to 50 C).

Aspect 51: The method or system of any preceding Aspect, wherein the gaseous reaction stream is characterized by a relative humidity being at least 75% (optionally at least 80%, optionally at least 85%, optionally at least 90%, optionally at least 95%, optionally at least 99%, optionally 100%).

Aspect 52a: The method or system of any preceding Aspect, wherein the pressure in the first reactor is selected from the range of greater than 0 bara to less than or equal to 20 bara. Aspect 52b: The method or system of any preceding Aspect, wherein the pressure in the first reactor is greater than or equal to 0.1 bara (optionally 0.2 bara, optionally 0.3 bara, optionally 0.5 bara, optionally 0.7 bara, optionally 0.9 bara, optionally 1.0 bara, optionally 1.1 bara, optionally 1.2 bara, optionally 1.3 bara, optionally 1.5 bara, optionally 2 bara) and less than or equal to 20 bara (optionally 19 bara, optionally 18 bara, optionally 15 bara, optionally 12 bara, optionally 10 bara, optionally 9 bara, optionally 8 bara, optionally 5 bara, optionally 3 bara, optionally 2.1 bara).

Aspect 53: The method or system of any preceding Aspect, wherein the first gaseous output stream is characterized by a CO₂ concentration being 20% or less (optionally 15% or less, optionally 10% or less, optionally 8% or less, optionally 5% or less, optionally 3% or less, optionally 2% or less, optionally 1% or less, optionally 0.5% or less, optionally 0.1% or less) of the initial concentration of CO₂ in the gaseous feed stream.

Aspect 54: The method or system of any preceding Aspect, wherein the first reactor is a fixed bed reactor.

Aspect 55: The method or system of Aspect 54, wherein the sorbent composition is characterized by an average particulate size selected from the range of 37 μm to 1 cm.

Aspect 56: The method or system of Aspect 54 or 55, wherein the spent-absorbent composition exits the first reactor in an aqueous slurry and wherein the aqueous slurry is provided to the sorbent-regeneration subsystem with or without prior separating the spent-sorbent composition from liquid water.

Aspect 57: The method or system of any Aspect 54-56, wherein the second reactor of the sorbent-regeneration subsystem is the same as the first reactor.

Aspect 58: The method or system of any Aspect 1-53, wherein the first reactor is a fluidized bed reactor.

Aspect 59: The method or system of Aspect 58, wherein the metal carbonate is characterized by an average particle size selected from the range of 37 μm to 2 mm.

Aspect 60: The method or system of Aspect 58 or 59, wherein the spent-sorbent composition exits the first reactor with the first gaseous output stream as particulates suspended therein; and wherein the sorbent-regeneration subsystem comprises one or more cyclones to separate out particulates of the spent-sorbent composition from CO₂ gas.

Aspect 61: The method or system of any Aspect 58-60, wherein the first reactor is operated continuously and wherein the second reactor of the sorbent-regeneration subsystem is different from the first reactor.

Aspect 62: The method or system of any preceding Aspect, wherein the gaseous feed stream is a flue gas or other industrial output gas.

Aspect 63a: The method or system of any preceding Aspect, wherein the sorbent composition in the first reactor comprises a fresh sorbent composition, the regenerated-sorbent composition, or a combination thereof. Aspect 63n: The method or system of any preceding Aspect, wherein at least a portion of the sorbent composition in the first reactor comprises a fresh sorbent composition, the regenerated-sorbent composition, or a combination thereof.

Aspect 64a: The method or system of any preceding Aspect, wherein the sorbent composition comprises one or more water-soluble additives, one or more water-insoluble additives, or a combination of these. Aspect 64b: The method or system of any preceding Aspect, wherein the sorbent composition comprises one or more water-insoluble metal carbonate materials (e.g., CaCO₃) and one or more water-soluble additives.

Aspect 65: The method any preceding Aspect comprising pre-treating the gaseous feed stream to remove liquid/condensed water from the gaseous feed stream.

Aspect 66: The method any preceding Aspect comprising heating the gaseous feed stream to a temperature greater than its dew point.

Aspect 67: The method any preceding Aspect comprising heating the gaseous feed stream prior to its entering the reactor.

Aspect 68: The method any preceding Aspect comprising heating the gaseous reaction stream in the first reactor or immediately prior to its entering the reactor to a temperature greater than its dew point in the first reactor.

Aspect 69: The method any preceding Aspect comprising controlling a temperature and/or pressure in the reactor to prevent water condensation such that gaseous feed stream has a temperature greater than its dew point in the first reactor.

Aspect 70: The method any preceding Aspect, wherein the step of regenerating comprises decomposing the metal bicarbonate material to reform one or more of the at least one metal carbonate material.

Aspect 71: The method any preceding Aspect, wherein step of regenerating comprises granulating, via granulation, the reformed one or more metal carbonate material to make the regenerated-sorbent composition having a larger average particulate size than the spent-sorbent composition and/or than an initial average particular size of the reformed metal carbonate material.

Aspect 72: The method any preceding Aspect comprising collecting the spent-sorbent composition from the first reactor and providing it to the sorbent-regeneration subsystem.

Aspect 73: The method any preceding Aspect, wherein the step of regenerating comprises (i) mixing the spent-absorbent composition from the first reactor, (ii) extruding the mixed composition, (iii) granulating and/or spheronizing the extruded composition, and (iv) drying the granulated and/or spheronized composition.

Aspect 74: The method any preceding Aspect, comprising forming the sorbent composition having the at least one metal carbonate material and at least one additive; wherein the step of forming the sorbent composition comprises (i) mixing the at least one metal carbonate and the at least one additive, (ii) extruding the mixed composition, (iii) granulating and/or spheronizing the extruded composition, and (iv) drying the granulated and/or spheronized composition thereby forming the sorbent composition.

Aspect 75a: The method any preceding Aspect, wherein step of regenerating comprises adding fresh sorbent composition, such that the regenerated-sorbent composition comprises some amount of fresh sorbent composition. Aspect 75b: The method any preceding Aspect, wherein step of regenerating comprises adding some amount of fresh one or more metal carbonate materials and/or some amount of fresh one or more additives, such that the regenerated-sorbent composition comprises some amount of fresh metal carbonate material(s) and/or some amount of fresh one or more additive(s).

Aspect 76a: The method or system of Aspect 1g or 1h, wherein the at least one metal carbonate material comprises CaCO₃. Aspect 76b: The method or system of

Aspect 1g or 1h, wherein the at least one metal carbonate material is CaCO₃. Aspect 76c: The method or system of Aspect 1g or 1h, wherein the at least one metal carbonate material comprises a water-insoluble metal carbonate material. Aspect 76d: The method or system of Aspect 1g or 1h, wherein the at least one metal carbonate material is water-insoluble.

The invention can be further understood by the following non-limiting examples.

### EXAMPLE 1

### A Fixed Bed CO₂ Capture System

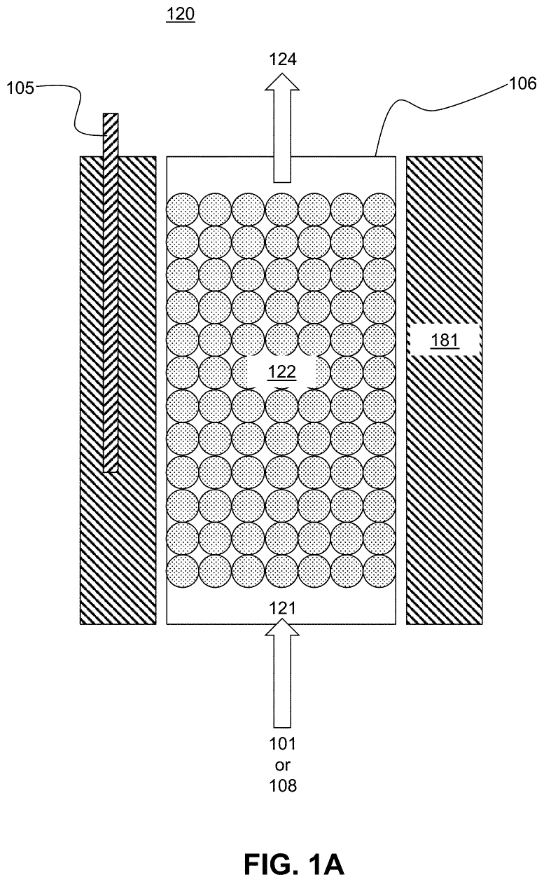

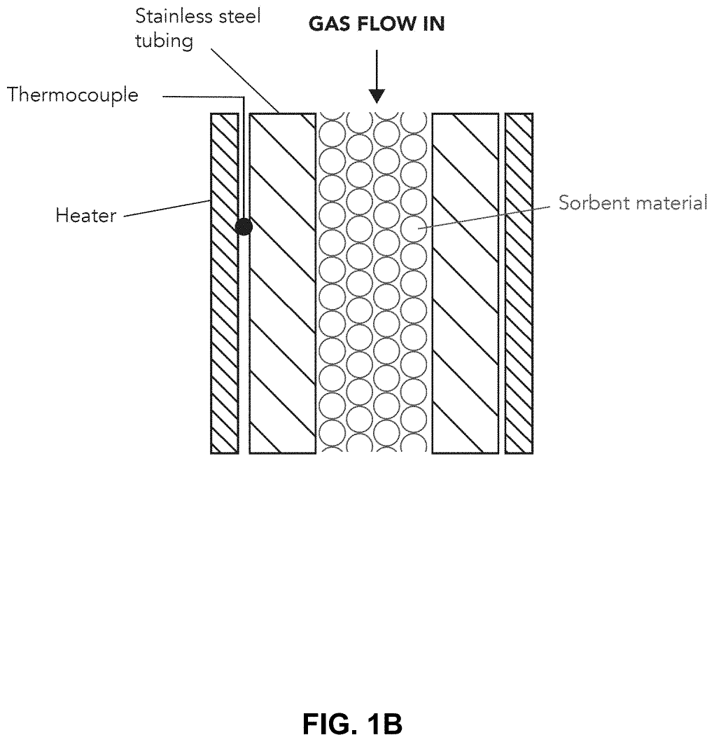

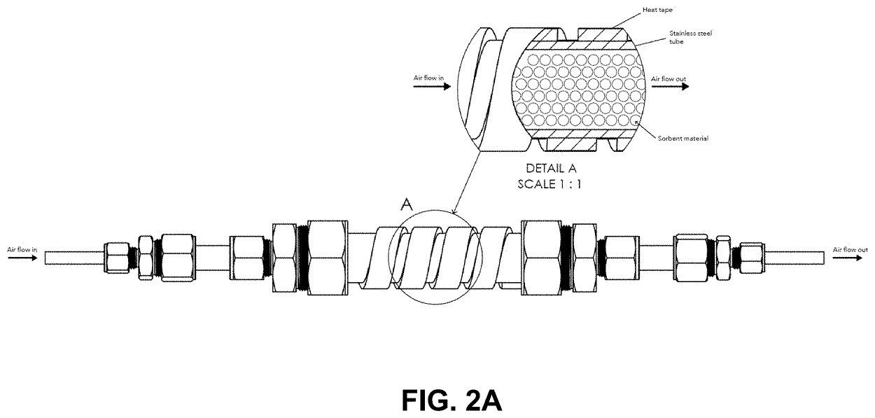

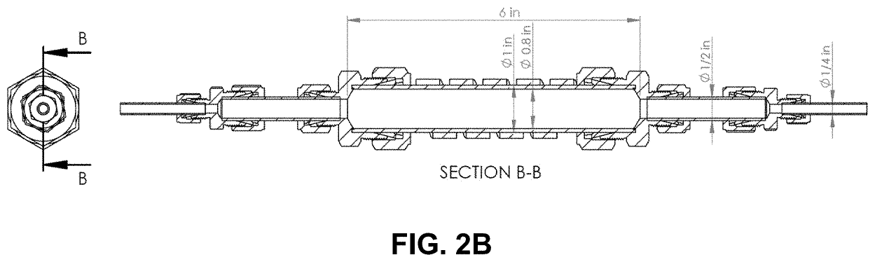

A schematic illustrating a fixed bed reactor of a CO₂ capture system, according to some aspects disclosed herein, is showing in FIG. 1A and FIG. 1B. FIGS. 2A and 2B show schematics of an exemplary fixed bed reactor of a CO₂ capture system, according to some aspects disclosed herein. The fixed bed reactor of FIG. 1A or FIG. 1B is optionally according to the reactor shown in FIGS. 2A and 2B, or a variation thereof. In aspects where reactor 320 in FIG. 3A is a fixed bed reactor, the fixed bed reactor is optionally according to the reactor shown in FIGS. 2A and 2B, or a variation thereof.

A gaseous feed stream 101 or pre-treated gaseous feed stream 108 is provided to chamber or cavity 106 of first reactor 120, becoming gaseous reaction stream 121 in first reactor 120. Chamber 106 optionally use glass or metal walls, such as stainless steel walls. In some aspects, chamber 106 is for example a glass or steel tube or other vessel having a longitudinal cavity. First reactor 120 optionally comprises a heater 181 to maintain the gaseous reaction stream 121 at a temperature sufficient to prevent water condensation, such as at least 0.5° C. (optionally at least 1° C., optionally at least 2° C.), above its dew point. A thermocouple 105 is used to measure temperature. A thermocouple or other temperature measurement device may be used within chamber 106 to measure the wet and/or dry bulb temperature of the gaseous reaction stream. Sorbent composition 122, in the form of granules of one or more metal carbonate materials, is provided in chamber 106. A first gaseous output stream 124 exits first reactor 120, output stream 124 having a reduced concentration of CO₂ due to its capture by sorbent composition 122.

For example, the heater is initially set to 60° C.±20 ° C., in some aspects for example. A gaseous feed stream, such as a flue gas, with CO₂ is provided into the reactor, shown in FIG. 1 as provided from the top in some aspects for example. In the reactor, the CO₂ gas in the gaseous stream, now referred to as the gaseous reaction stream, reacts with the metal carbonate material (e.g., CaCO₃ sorbent granules) of the sorbent composition in the reactor. The sorbent composition is optionally in the form of granules and in a packed bed configuration. Reaction of the CO₂ gas with the metal carbonate material produces a spent-sorbent composition having a metal bicarbonate material. A (first) gaseous output stream then exists the reactor, optionally at the bottom as shown in FIG. 1. The (first) gaseous output stream is either free of CO₂ or has a substantially lower concentration of CO₂ than that in the gaseous feed stream (e.g., ≥80% less CO₂, e.g., ≥90% less CO₂).

Optionally, in some aspects for example, the CO₂ capture system comprises a separate sorbent-regenerations subsystem to which the first output gaseous stream is provided from the (“first”) reactor.

Optionally, in some aspects for example, the “first” reactor is itself then used as part of a sorbent-regenerations subsystem, wherein the “first” reactor may optionally be referred to as a “second” reactor when used as part of a sorbent-regenerations system or process thereof. In some aspects for example, after some finite time of operation of the first reactor, for capturing CO₂, the flow of the gaseous feed stream is optionally shut off, and the heater increases the temperature in the reactor, optionally to 160° C.±20° C., in some aspects for example, to decompose metal bicarbonate and reform metal carbonate, thereby regenerating the sorbent composition. During regeneration, CO₂ gas is released as part of the decomposition of metal bicarbonate into metal carbonate. This released CO₂ gas is directed to a desired exit, and the regenerated-sorbent composition is ready to capture CO₂ again at after the temperature is again decreased to the appropriate temperature for CO₂ capture in the reactor (e.g., 60° C.±20° C.).

Optionally, in some aspects for example, some amount of liquid water is present in the first reactor, resulting in formation of a slurry comprising spent-sorbent composition (dissolved, dispersed, and/or suspended in water), optionally also sorbent composition (dissolved, dispersed, and/or suspended in water). Optionally, in some aspects for example, this slurry is processed to separate out and/or precipitate solid particulates, forming a solids stream. Optionally, in some aspects for example, this solids stream is provided to the reactor during the regeneration cycle in order to decompose metal bicarbonate thereof and reform metal carbonate material. Optionally, in some aspects for example, this solids stream is provided to a separate sorbent-regeneration subsystem to regenerator the sorbent composition which is then subsequently recycled back to the first reactor. The sorbent-regeneration subsystem optionally includes granulation to regenerate the sorbent composition.

### EXAMPLE 2

### A Fluidized Bed CO₂ Capture System

A process flow illustration of a system for capturing CO₂, optionally having a circulating fluidized bed reactor, according to some aspects disclosed herein, is discussed here.

The first reactor, optionally a fluidized bed reactor, optionally a calciner, operates at 60° C.±20° C., in some aspects for example, and the regenerator at 160° C.±20° C., in some aspects for example. A gaseous feed stream, such as flue gas, optionally pre-treated, containing CO₂ enters the first reactor and fluidizes the sorbent composition having metal carbonate solid particles, in some aspects for example, such as CaCO₃ in some aspects for example, in the first reactor (e.g., calciner). Reaction between the sorbent composition (e.g., CaCO₃), CO₂, and H₂O(g) vapor takes places throughout the first reactor as the gaseous reaction stream, and optionally solid particles (e.g., dust) such as of spent-sorbent composition, travels upwards in the riser, a part of the first reactor optionally. In some aspects for example, the first gaseous output stream leaving the first reactor is initially a mixture of solid particles, such as spent-sorbent composition dust, and CO₂, optionally further having other gaseous species such as H₂O and/or impurity species. Subsequently, in some aspects for example, a first separator device, such as a cyclone, separates the solid particles of spent-sorbent composition from the gas mixture into a gas stream (e.g., second gaseous output stream (e.g., treated flue gas) and a solid stream having collected/separated spent-sorbent composition (e.g., Ca(HCO₃)₂). The solid stream of collected spent-sorbent composition then enters the regenerator of the sorbent-regeneration subsystem, in some aspects for example, where the elevated temperature regenerates or reforms the metal carbonate material (e.g., CaCO₃) from the spent-sorbent composition (e.g., Ca(HCO₃)₂) and releases CO₂ (optionally humid CO₂), in some aspects for example, as third gaseous output stream. Optionally, in some aspects for example, the third gaseous output stream, released from the regenerator, may initially carry fine solid particles upwards into a second separator device, such as a cyclone, which then separates the CO₂ (optionally humid CO₂) gas stream from the solids, forming a fourth gaseous output stream (having the separator CO₂, optionally humid CO₂) and another solid stream that is returned the solids back to the regenerator, in some aspects for example. Optionally, but not necessarily, the first and second separator devices are same device. Optionally, in some aspects for example, a gaseous feed stream pre-treatment subsystem pretreats the gaseous feed stream prior to. The pre-treatment subsystem may remove liquid or condensed water from the gaseous feed stream, adds humidity or gaseous water vapor content to the gaseous feed stream, and/or removes or condenses-out impurity species such as SOₓ, and/or NOₓ species. Optionally, in some aspects for example, a humidity-removal subsystem is used to remove at least a portion of water vapor from the fourth gaseous output stream to produce a dry fifth gaseous output stream comprising dry CO₂. Optionally, in some aspects for example, the same or different humidity-removal subsystem is used to remove at least a portion of water vapor from the second gaseous output stream.

### EXAMPLE 3

### A Fluidized Bed CO₂ Capture System

A process flow illustration of a system 300(II) for capturing CO₂, optionally having a circulating fluidized bed reactor, according to some aspects disclosed herein, is shown in FIG. 3B.

A gaseous feed stream 301 containing CO₂, such as a flue gas, is optionally pre-treated in a feed pre-treatment subsystem 310. Feed pre-treatment subsystem optionally has a humidifier 311 to increase the water vapor content of the gaseous feed stream, thereby forming a pre-treated gaseous feed stream 308, prior to its entering first reactor 320 (“absorber”) as a gaseous feed stream 321. Gaseous feed stream 321 fluidizes sorbent composition 322, which comprises a metal carbonate material, optionally in the form of solid particulates or granules.

Reaction (FX2) among sorbent composition 322, or metal carbonate material (e.g., CaCO₃) thereof, CO₂ gas, and H₂O(g) vapor takes places throughout first reactor 320 as gaseous reaction stream 321 flows through first reactor 320 and comes in contact with sorbent composition 322. First reactor 320 is optionally a fluidized bed reactor. The reaction (FX2) produces a spent-sorbent composition 323 having a metal bicarbonate material. In some aspects, fluidization of sorbent composition 322 by gaseous reaction stream 321 causes abrasion forces that decrease the particulate size of the solids in reactor 320, thereby forming fine particulates(e.g., dust) of spent-sorbent composition 323. At least a portion of the fine particulates of spent-sorbent composition 323 are carried or aerosolized by the gaseous reaction stream. A first gaseous output stream 324 exits reaction 320, the first gaseous output stream 324 having a reduced concentration of CO₂ than the gaseous reaction stream immediately prior to its initial contact with sorbent composition. Optionally, in some aspects, first gaseous output stream 324 comprises other gaseous species or aerosolized or suspended species, such as H₂O and/or impurity species. Optionally, in some aspects, first gaseous output stream 324 comprises fine particulates of spent-sorbent composition (e.g., as dust). Optionally, in some aspects, first gaseous output stream 324 is provided to a first separation device 331, which is optionally a cyclone, in some aspects. In some aspects, first separation device 331 separates first gaseous output stream 324 into a second gaseous output stream 325 and a solid stream 326, solid stream 326 having spent-sorbent composition 323. In some aspects, solid stream 326 is provided to a second reactor 341, optionally referred to as a regenerator, of sorbent-regeneration subsystem 340. Second reactor 341 has an elevated temperature (e.g., 160° C.±20° C.) sufficient to decompose the metal bicarbonate material (e.g., Ca(HCO₃)₂) from solid stream 326 thereby reforming the metal carbonate material (e.g., CaCO₃) and releasing CO₂ (optionally humid CO₂), in some aspects for example, as third gaseous output stream 342. Optionally, in some aspects for example, the reformed metal carbonate material is removed from second reactor 341 and provided back to first reactor 320 as regenerated-sorbent composition 322(b) in solids stream 343, further optionally with additional processing thereof, such as granulation, or further optionally without additional processing thereof.

Third gaseous output stream 342 comprises CO₂ (optionally humid CO₂), which is formed in and released from second reactor 341 as a result of the metal bicarbonate decomposition. Third gaseous output stream 342 optionally, in some aspects, comprises fine solid particulates carried thereby or suspended therein, the fine solid particulates having the reformed metal carbonate, and optionally also some amount of un-decomposed metal bicarbonate. Third gaseous output stream 342 is optionally, in some aspects, provided to a second separation device 332, such as a cyclone, which separates third gaseous output stream 342 into a fourth gaseous output stream 351 and a solids stream 352. Fourth gaseous output stream 351 comprises CO₂ (optionally humid CO₂). Optionally, in some aspects, fourth gaseous output stream 351 further comprises some amount of fine solid particulates (e.g., fine dust) comprising of reformed metal carbonate material and/or un-decomposed metal bicarbonate material from second reactor 341. Solids stream 352 comprises reformed metal carbonate material, and may optionally in some aspects comprise some amount of un-decomposed metal bicarbonate material.

Optionally, in some aspects for example, solids stream 352 is provided back to second reactor 341 in order to further decompose any remaining un-decomposed metal bicarbonate. Solids stream 343 may therefore comprise material having arrived from solids stream 352. Optionally, in some aspects for example, solids stream 352 is provided back to first reactor 320 as regenerated-sorbent composition 322(c), further optionally with additional processing thereof, such as granulation, or further optionally without additional processing thereof.

Optionally, in some aspects for example, fourth gaseous output stream 351 is provided to a third separation device 333, such as a cyclone. Third separation device 333 separator fourth gaseous output stream 351 into a fifth gaseous output stream 353 and a solids stream 354. Solids stream 354 comprises the reformed metal carbonate material. Optionally, in some aspects for example, solids stream 354 further comprises some amount of un-decomposed metal bicarbonate material. Optionally, in some aspects for example, solids stream 354 is provided back to first reactor 320 as regenerated-sorbent composition 322(c), further optionally with additional processing thereof, such as granulation, or further optionally without additional processing thereof. Optionally, in some aspects for example, solids stream 354 is further processed to increase particular size, such as by providing solids stream 354 to a solids-processing device 345, which is optionally a granulator and/or spheronizer. Solids-processing device 345 produces a solids stream 356, characterized by an average particulate size greater than that in solids stream 354, optionally greater than in solids stream 352, optionally greater than in solids stream 326. Optionally, in some aspects for example, solids stream 356 is provided back to first reactor 320 as regenerated-sorbent composition 322(d), further optionally with additional processing thereof or further optionally without additional processing thereof. Optionally, in some aspects for example, solids stream 356 provided back to second reactor 341, wherein any un-decomposed metal bicarbonate material may be further decomposed to metal carbonate. Solids stream 343 may therefore optionally comprise some amount of material from solids stream 356.

Optionally, in some aspects for example, separation devices 331, 332, and 333, if used, can be one, two, three, or more separation devices. Optionally, in some aspects for example, any of the separation devices may optionally be used to receive, and separate, any one or more of the aforementioned gaseous streams. For example, separation device 331 may be used to receive stream 342 instead of separation device 332. For example, separation device 332 may be used to receive stream 324 instead of separation device 331.

Optionally, in some aspects for example, fifth gaseous output stream 353 is a product stream of system 300(II). Optionally, in some aspects for example, fifth gaseous output stream 353 is further processed, such as via a de-humidification device 360 to remove or reduce water vapor from fifth gaseous output stream 353. Optionally, in some aspects for example, fifth gaseous output stream 353, or the dried CO₂ gas thereof, is concentrated, liquefied, and/or stored or sequestered.

Optionally, in some aspects for example, some amount of liquid water is present in first reactor 320, resulting in formation of a slurry 326 comprising spent-sorbent composition 323 (dissolved, dispersed, and/or suspended in water), optionally also sorbent composition 322 (dissolved, dispersed, and/or suspended in water). Optionally, in some aspects for example, slurry 326 is processed to separate out and/or precipitate solid particulates, forming solids stream 327. Optionally, in some aspects for example, solids stream 326 or solids stream 327 is provided to sorbent-regeneration subsystem 340 in order to decompose metal bicarbonate material therein and regenerate sorbent composition 322. Optionally, in some aspects for example, solids stream 326 or solids stream 327 is provided to second reactor 341. Optionally, in some aspects for example, solids stream 326 or solids stream 327 is provided to a different regenerator reactor (or, third reactor 346) of sorbent-regeneration subsystem 340, third reactor 346 likewise having an elevated temperature sufficient to decompose metal bicarbonate material into metal carbonate material.

### EXAMPLE 4

### CO₂ Capture Aspects

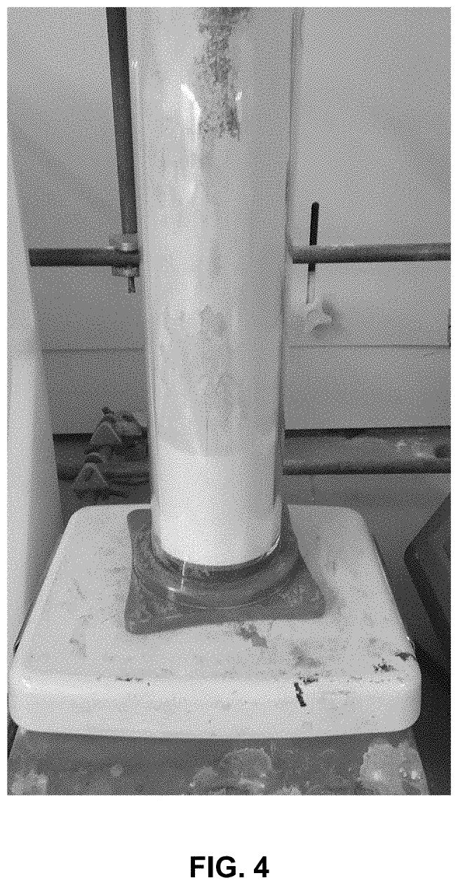

FIG. 4 is a photograph of an experimental fluidized bed reactor, according to some aspects disclosed herein. In an example, the reactor is operated at room temperature and pressure, using a gaseous feed stream being approximately 50 vol. % CO₂ and balance N₂ with approximately 50% relative humidity (“RH”). In an example, the reaction time in the reactor is approximately 0.1 seconds. Table 1 shows examples of experimental results using this reactor, showing measured CO₂ capture efficiency for different metal carbonate materials as sorbent compositions.

TABLE 1

| Fluidized bed sorbent | Capture efficiency |
|---|---|
| Na₂CO₃ powder | 93% |
| K₂CO₃ powder | 96% |
| CaCO₃ powder | 97% |

### EXAMPLE 4

### A Fixed Bed CO₂ Capture System

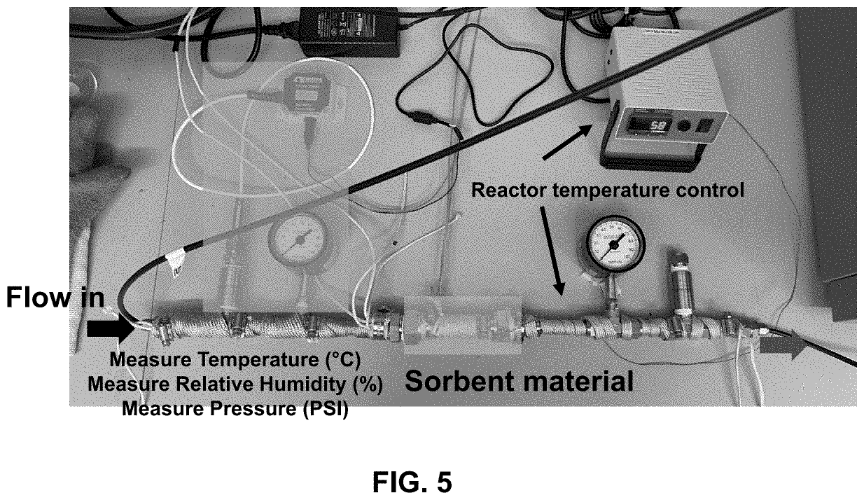

FIG. 5 is a photograph of an experimental fixed bed reactor, according to some aspects disclosed herein. In an example, the reactor is operated at room temperature and pressure, using a gaseous feed stream having a temperature of approximately 65° C., at approximately 1 atm, having approximately 10 vol. % CO₂ and balance Ar, with relative humidity of approximately 100%. In an example, the reaction time in the reactor is approximately 30 to 35 seconds. Table 2 shows examples of experimental results using this reactor, showing measured CO₂ capture efficiency for different sorbent compositions.

TABLE 2

| Fixed bed sorbent | Capture efficiency |
|---|---|
| K₂CO₃ powder | 99% |
| K₂CO₃-impregnated zeolite | 41% |

### EXAMPLE 5

### An Exemplary Humidifier System

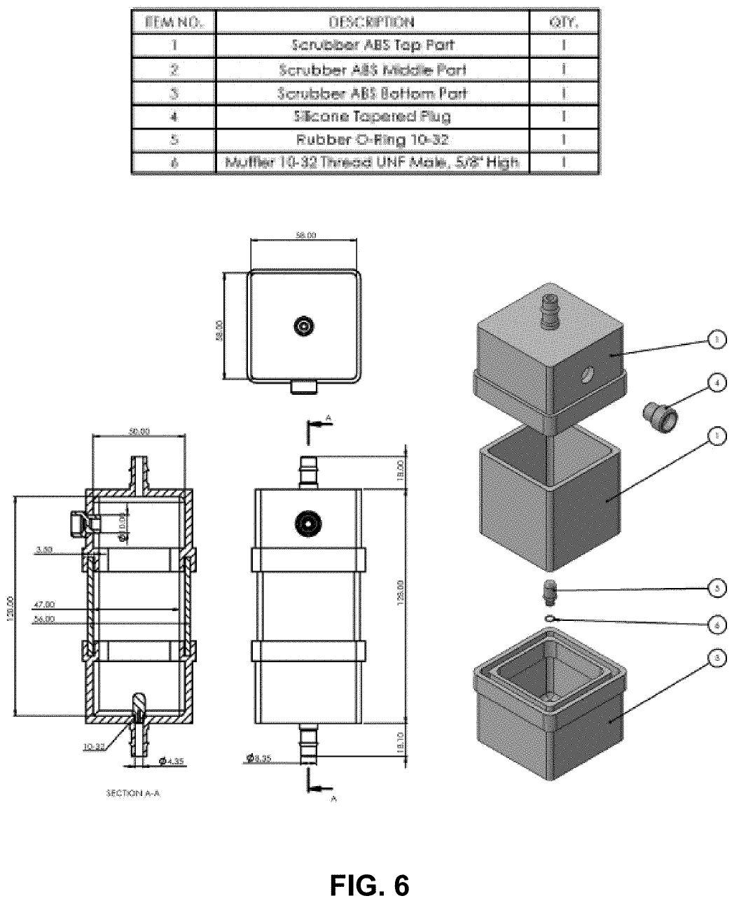

FIG. 6 shows schematics of a humidification device, for a feed pre-treatment subsystem, according to some aspects disclosed herein. In an example, a humidification device comprises a pressure release device. In an example, a humidification device comprises a scrubber top part (1), a scrubber middle part (2), and a scrubber bottom part (3). In an example, a humidification device comprises a silicone tapered plug (4) and rubber o-ring (5). In an example, a humidification device comprises a muffler brass fitting (6).

### EXAMPLE 6

### A CO₂ Capture System

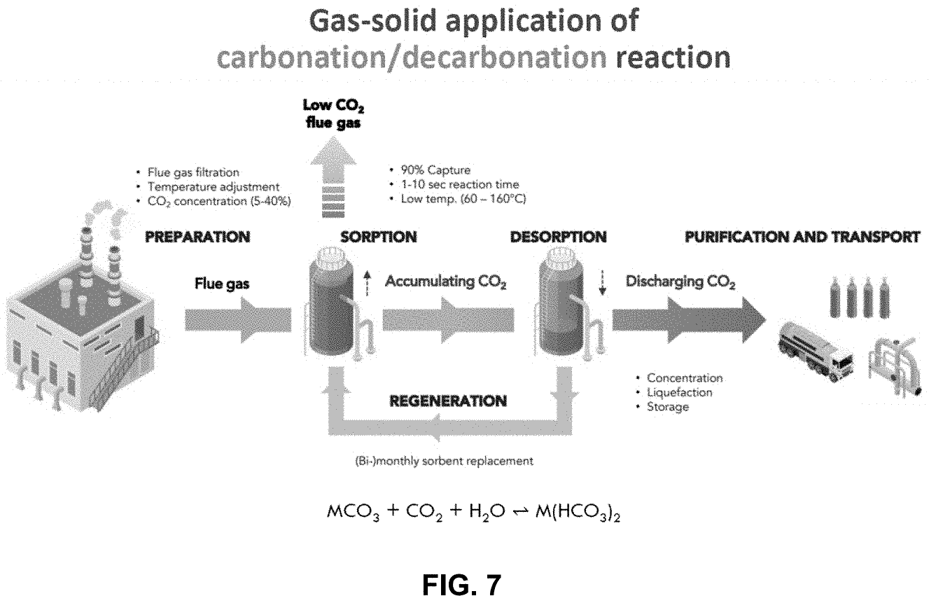

FIG. 7 is a process flow diagram illustrating an applied example of a CO₂ capture system, according to some aspects disclosed herein.

### EXAMPLE 7

### Discussion of Exemplary Temperature and Pressure Conditions for CO₂ Capture and Spent-Sorbent Regeneration

In aspects, for example, the pressure during CO₂ capture in the reactor, or the pressure to which the sorbent composition is exposed as it reacts with the CO₂ and humidity in the gaseous reaction stream, is selected from the range of greater than 0 bar (absolute) to less than or equal to 20 bar. In aspects, for example, the pressure at which metal bicarbonate material, of spent-absorbent composition, is decomposed is selected from the range of greater than 0 bar (absolute) to less than or equal to 20 bar. In aspects, for example, the pressure in the regeneration reactor (e.g., “second reactor”), or the pressure at which metal bicarbonate material is decomposed, is less than the pressure in the CO₂ capture reactor (e.g., “first reactor), or the pressure during CO₂ capture in the reactor or the pressure to which the sorbent composition is exposed as it reacts with the CO₂ and humidity in the gaseous reaction stream, for a given system. In aspects, for example, the regeneration reactor (e.g., “second reactor”) and/or the CO₂ capture reactor (e.g., “first reactor) can be at a lower pressure than atmospheric pressure, such as when using forced convection, such as via fans or pumps, to move gas throughout the system. In aspects, for example, the CO₂ capture reactor (e.g., “first reactor) can be at a lower pressure than atmospheric pressure, such as when using forced convection, such as via fans or pumps, to move gas through the CO₂ capture reactor instead of compressors.

In aspects, for example, the temperature during CO₂ capture in the reactor, or the temperature of the gaseous reaction stream as it reacts with the sorbent composition, is selected from the range of greater than or equal to approximately 20° C. to less than or equal to approximately 70° C. In aspects, for example, the temperature at which metal bicarbonate material, of spent-absorbent composition, is decomposed is selected from the range of greater than or equal to approximately 20° C. to less than or equal to approximately 200° C.

The selection of sorbent composition, and particularly the metal carbonate material (e.g., Na₂CO₃ vs. K₂CO₃ vs. CaCO₃) and the physical form of the sorbent composition (e.g., powder vs. granular vs. on a support such as zeolite) may influence or determine the preferred temperature and pressure used for CO₂ absorption and for the regeneration. In some aspects, for example, if the sorbent composition is K₂CO₃ powder, a preferred CO₂ capture temperature may be 60 C at 1 bara and a preferred regeneration temperature may be greater than or equal to 160 C at 1 bara. In some aspects, for example, if the sorbent composition is CaCO₃ powder, a preferred CO₂ capture temperature may be approximately 20-50 C at 1 bara and a preferred regeneration temperature may be approximately within 20-200 C at 1 bara.

Generally, but not necessarily, there may be an inverse relationship for temperature and pressure for regeneration reaction conditions. In some aspects, for example, a preferred regeneration temperature of K₂CO₃ powder may be 200 C at 1 bara but 100 C at 0.01 bara.

As an illustrative example, CO₂ capture may be performed at approximately 60 C and approximately 0.8 bara and regeneration at approximately 200 C and approximately 0.8 bara. As another illustrative example, CO₂ capture may be performed at approximately 30 C and approximately 3 bara and regeneration at approximately 160 C and approximately 1.2 bara. As another illustrative example, CO₂ capture may be performed at approximately 60 C and approximately 0.6 bara and regeneration at approximately 60 C and approximately 0.01 bara.

### EXAMPLE 8

### Multi-Ingredient Sorbent

A multi-ingredient sorbent composition is made in the form of granules, optionally approximately 1 mm granules. In this example, a multi-ingredient sorbent composition is made using a mixture having:
approximately 88 wt. % (dry basis) metal carbonate, such as CaCO₃;
approximately 12 wt. % (dry basis) of one or more additives, such as starch; and
approximately 22 wt. % (relative to above components) moisture content, optionally added during mixing to facilitate extrusion and spheronization.

Granules are formed from this mixtures, using mixing, extrusion, spheronization, and drying.

Starch acts as a binder for CaCO₃ to form mechanically strong granules, useful, for example, for withstanding fluidized bed reactor conditions. After the granules are ground to dust due to attrition in the reactor as a result of the abrasive condition of a fluidized bed reactor, the collected spent-sorbent dust can be recycled to re-manufacture the granules.

The multi-ingredient sorbents of this example may, for example, be well suited for fluidized bed reactors because of the ease of manufacturing using recycled sorbent dust. The multi-ingredient sorbents of this example are also useful for fixed bed reactors, where the collected sorbent slurry is recycled through the extrusion-spheronization method.

### EXAMPLE 9

### Multi-Ingredient Sorbent

A multi-ingredient sorbent composition is made in the form of granules, optionally approximately 1 mm granules. In this example, a multi-ingredient sorbent composition is made using a mixture having:
approximately 72 wt. % (dry basis) first metal carbonate, such as CaCO₃;
approximately 3 wt. % (dry basis) second metal carbonate, such as Al₂O₃;
approximately 10 wt. % (dry basis) of first additive, such as starch;
approximately 15 wt. % (dry basis) of second additive, such as HNO₃ (70% solution); and
approximately 22 wt. % (relative to above components) moisture content, optionally added during mixing to facilitate extrusion and spheronization.

Granules may be formed from this mixtures such as using mixing, extrusion, spheronization, and drying.

HNO₃ reacts with metal carbonate (Al₂O₃ and/or CaCO₃) to form a cross-linked structure. Starch acts as a filler that can be washed away at the end of the manufacturing process, leaving a porous scaffold structure behind for a high specific surface area.

The multi-ingredient sorbents of this example may, for example, be well suited for fixed bed reactors because of the high internal surface area, making CO₂ capture efficient without the vigorous mixing of the fluidized environment. The cross-linked structure is mechanically strong to withstand weight due to tall packing. The multi-ingredient sorbents of this example are also useful for fluidized bed reactors, in which case the high attrition environment may result in sorbent granules needing to be recycled and re-manufactured frequently.

### EXAMPLE 10

### Forming Multi-Ingredient Sorbent

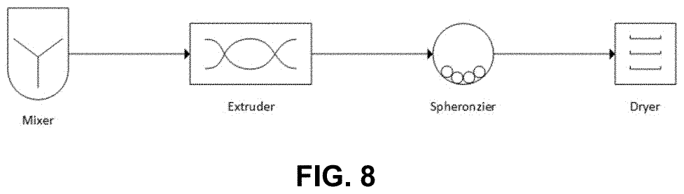

FIG. 8 is a schematic showing an exemplary process for making a multi-ingredient sorbent composition, according to some aspects. The process starts with a mixture, which may be a powder of ingredients, which includes fresh/new material and/or spent-sorbent composition (e.g., attrition ash from a fluidized bed reactor and/or from slurry waste from a fixed bed reactor). The mixture may for example be any of the mixtures describes in Examples 8, 9, or 10. The mixture of ingredient powder optionally, but not necessarily, has an average particulate size of 37 μm or less.

For example, mixing may be performed dry or wet mixing using. The mixture, optionally wetted, is optionally extruted using a granulator such as an LCI laboratory Multi-Granulator Model MG-55. Extrudates are optionally then spheronized, for example using an LCI Laboratory Marumerizer Model QJ-230T. The spheronized composition is then optionally dried using a dryer such as a Sherwood Fluid Bed Dryer Model M501.

For example, the extruder/granulator, such as MG-55, may be equipped with a 1.0 mm hole diameter by 1.0 mm thick dome die. For example, the MG-55 screw speed set point may be 55 rpm, and optionally remains constant throughout the extrusion. The spheronizer, such as the QJ-230T, is optionally equipped with a 2.0 mm friction plate and ran at speeds between 800-1000 rpm, optionally for short periods of time such as 10-15 seconds.

### EXAMPLE 11

### Other Multi-Ingredient Sorbent Mixtures and Compositions

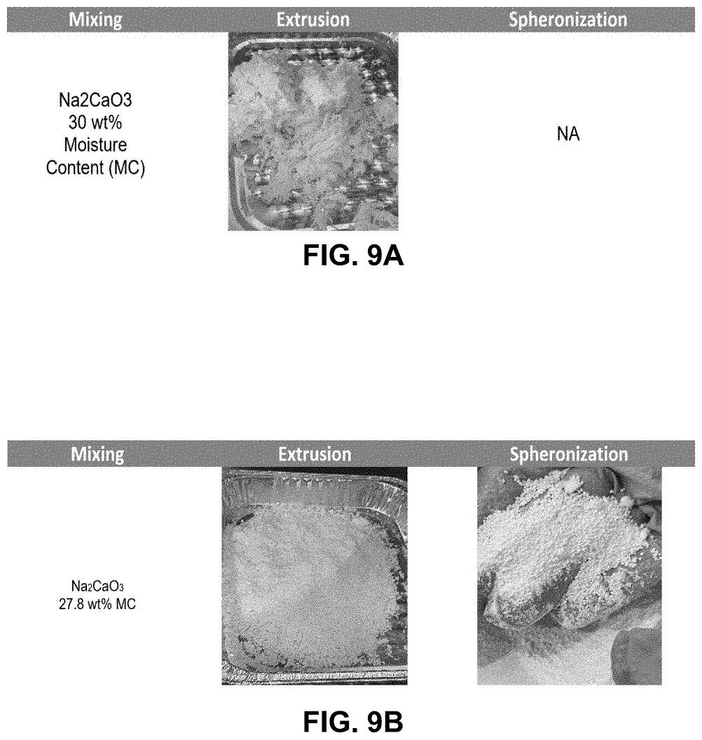

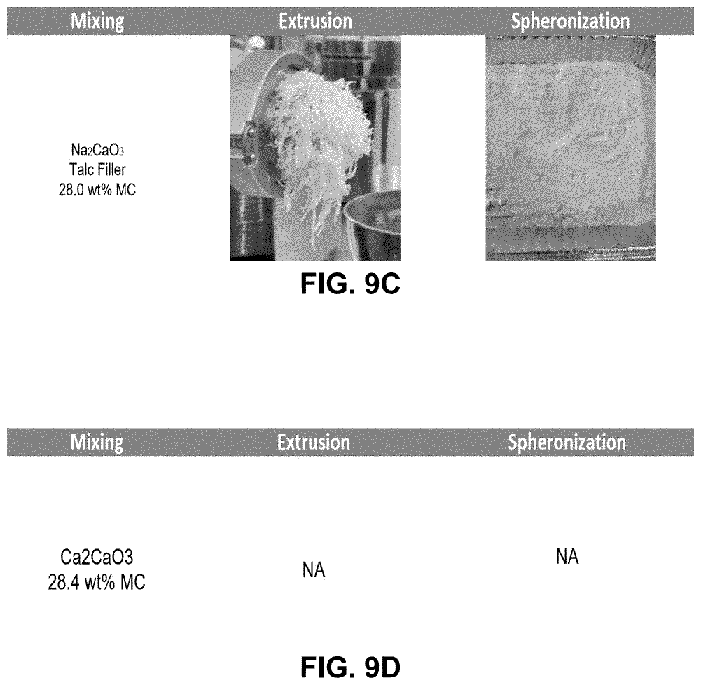

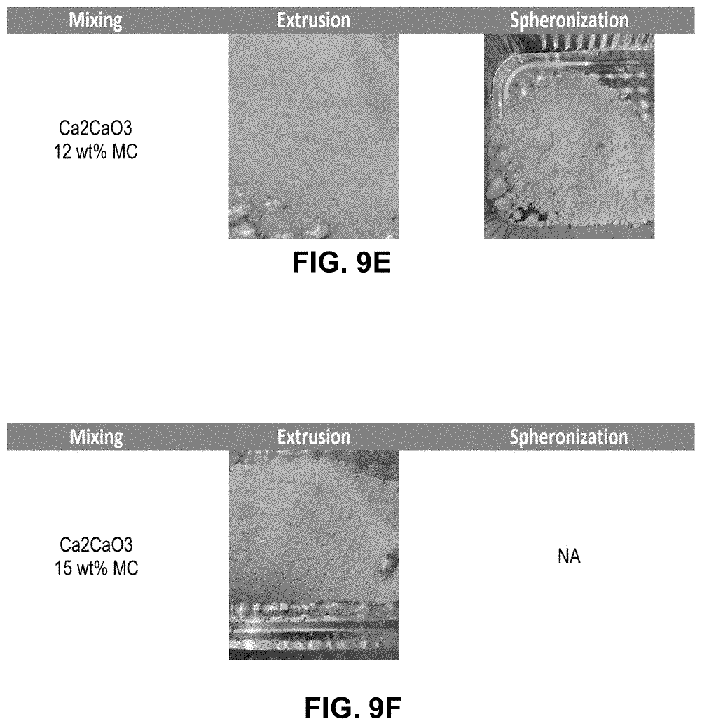

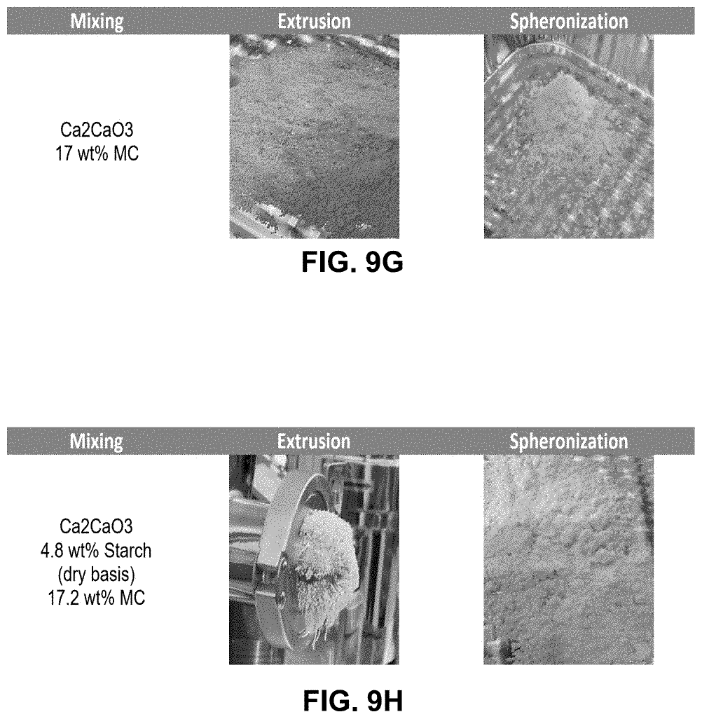

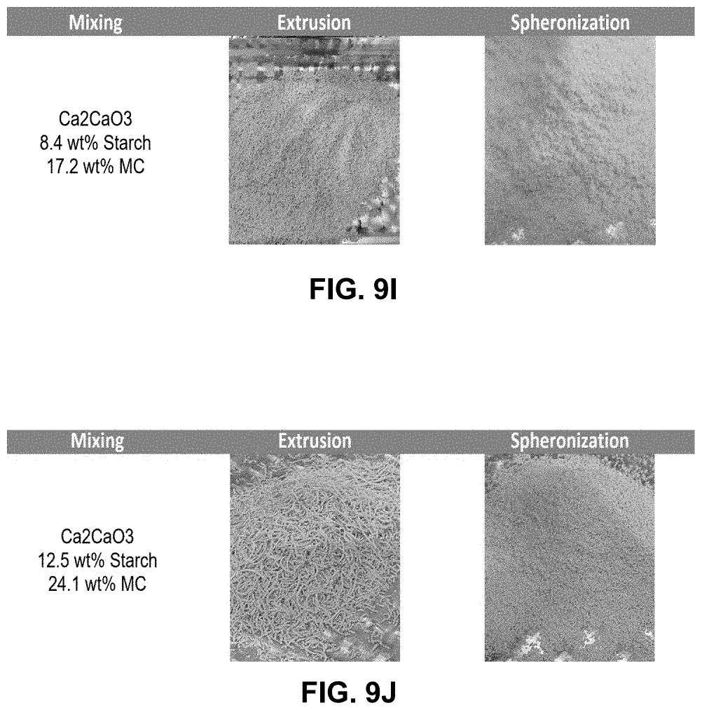

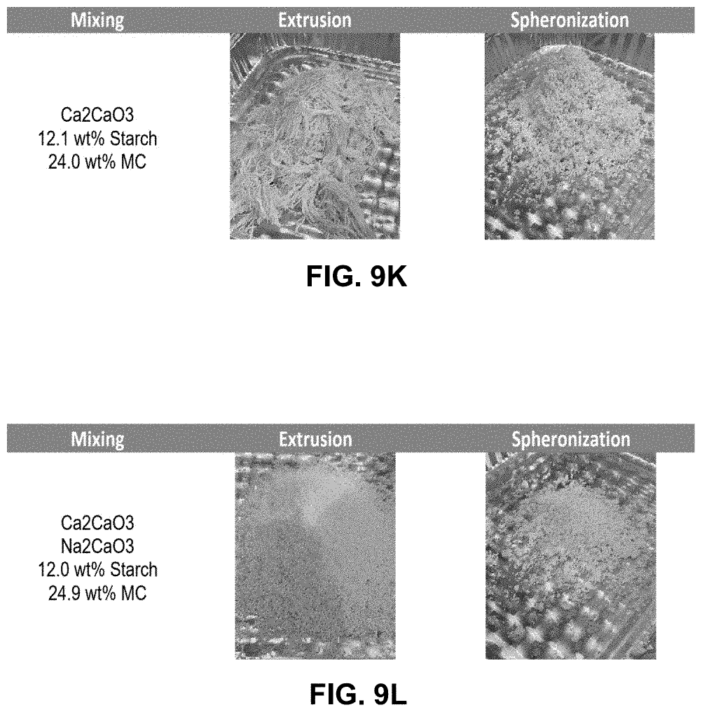

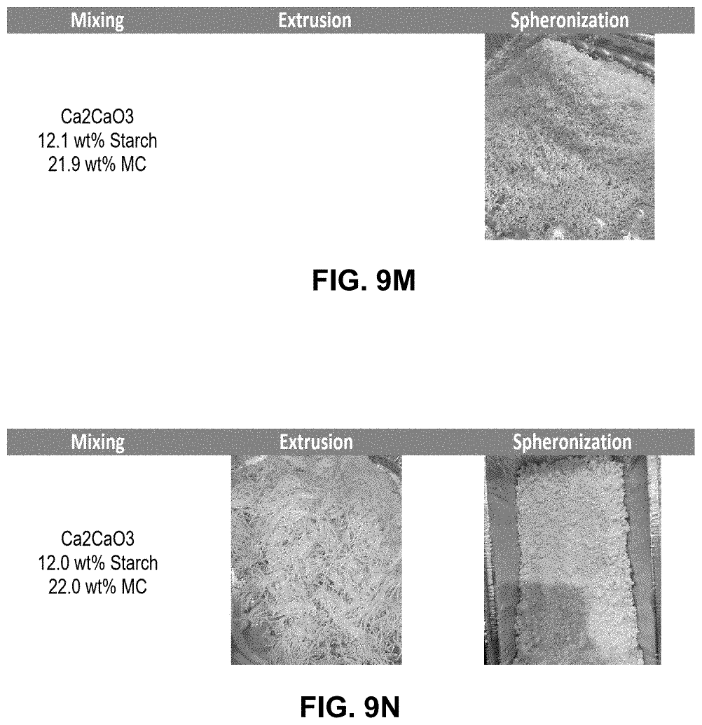

FIGS. 9A-9N shows exemplary mixtures used with processes according to Example 10 and shows photographs of corresponding resulting sorbent compositions.

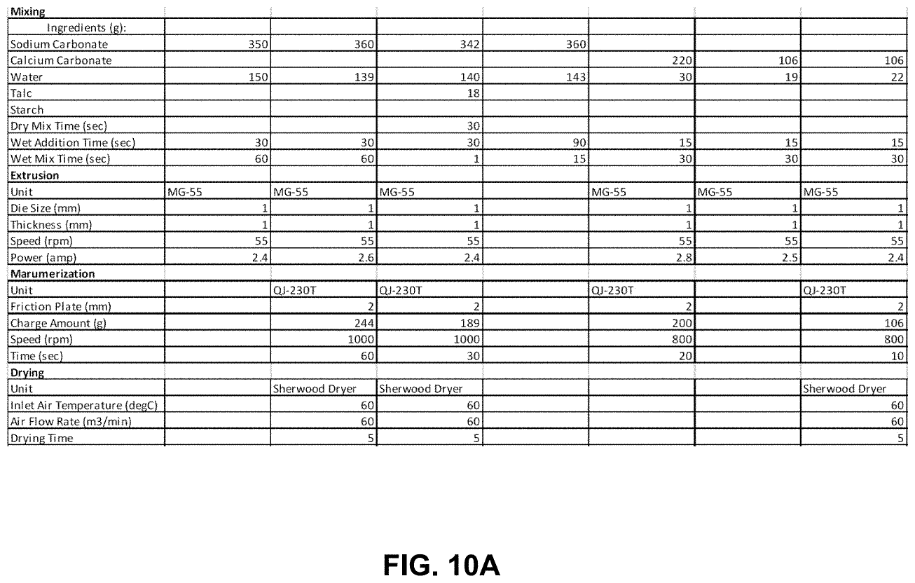

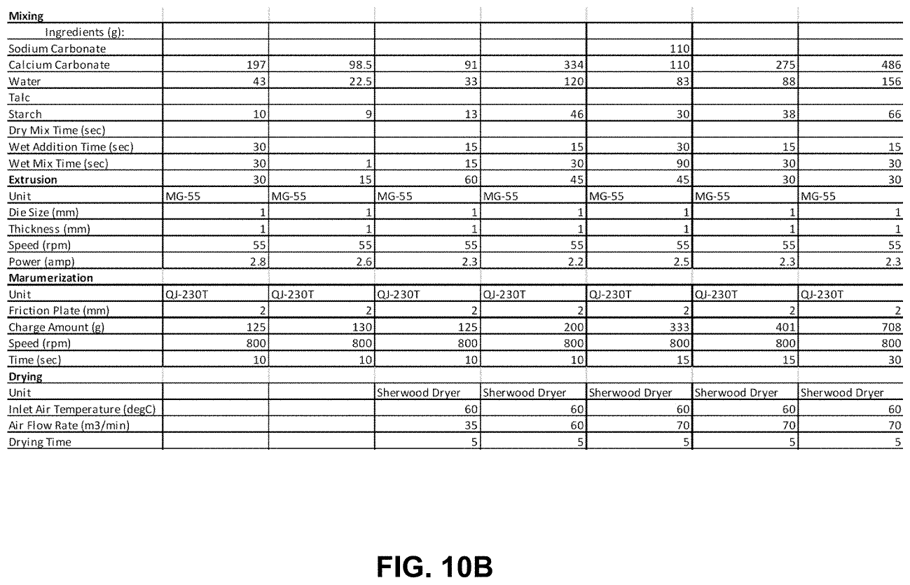

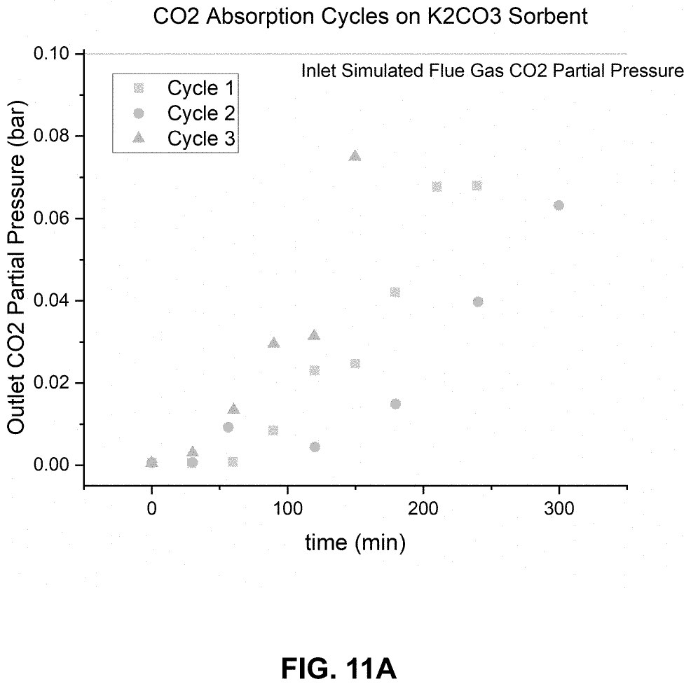

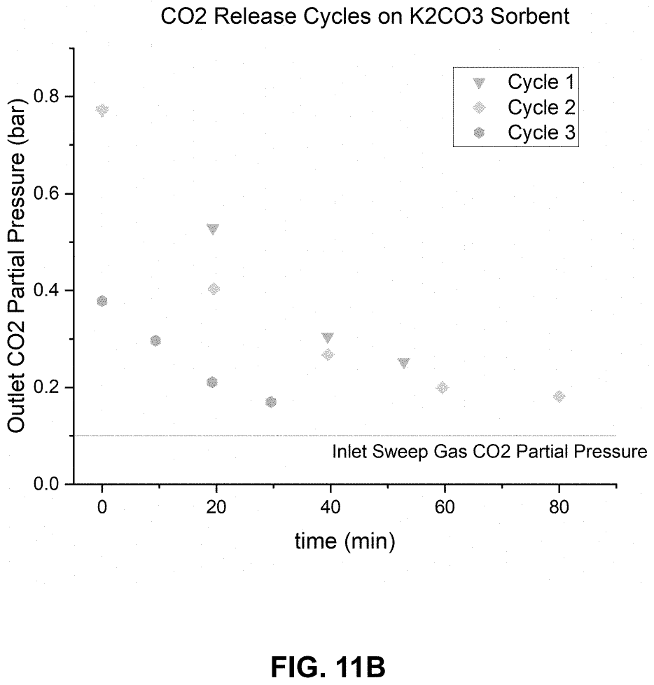

FIGS. 10A-10B are tables detailing exemplary processes and mixtures, according to some aspects, used to make multi-ingredient sorbent compositions.

### EXAMPLE 12

### Pre-Treatment of Gaseous Feed Stream

In an example, the gaseous feed stream, such as flue gas, can be pre-treated to increase its relative humidity using evaporative humidification, such as by passing a feed stream through a hot water bath. Evaporative humidification can result in high relative humidity and low, and even near negligible, condensed water content in the resulting pre-treated gaseous stream.

In an example, the gaseous feed stream, such as flue gas, can be pre-treated to increase its relative humidity using steam mixing, such as by mixing steam with or introducing steam to the feed stream. Steam mixing can result in high relative humidity, and low to moderate condensed water content in the pre-treated gaseous stream, such as between 0 wt. % to 30 wt. % condensed water.

The line (e.g., pipe or tubing) connecting the pre-treatment subsystem and the CO₂ capture reactor (e.g., first reactor) can be heat-traced and/or insulated to minimize heat loss and subsequent condensation. If significant water vapor condenses prior to reaching the entrance of the reactor, a float valve or steam trap is optionally installed to remove the condensed water from the gas stream, such that the gaseous stream immediately prior to entering the reactor and/or immediately prior to contacting sorbent composition in the reactor preferably has less than 5 wt. % condensed water.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Certain molecules disclosed herein may contain one or more ionizable groups [groups from which a proton can be removed (e.g., —COON) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every device, system, subsystem, material, composition, formulation, combination of components, and method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A system for capturing CO₂ gas, the system comprising:
a gaseous feed stream having an initial concentration of the CO₂ gas;
wherein the gaseous feed stream is directly or indirectly provided to a first reactor as a gaseous reaction stream;
the first reactor comprising a sorbent composition and the gaseous reaction stream flowing therein, the gaseous reaction stream being in contact with the sorbent composition; and
a first gaseous output stream that exists the first reactor, the first gaseous output stream having a concentration of CO₂ being less than the initial concentration of CO₂ in the gaseous feed stream;
wherein:
the gaseous reaction stream comprises the CO₂ gas and is characterized by a relative humidity of at least 5%;
the sorbent composition comprises at least one metal carbonate material that reacts with the CO₂ gas of the gaseous reaction stream thereby reducing CO₂ gas concentration in the gaseous reaction stream; and
wherein:
(a) the first reactor comprises 35 wt. % or less of liquid water by weight of the sorbent composition and liquid water; and/or
(b) the gaseous reaction stream has 35 wt. % or less of condensed water by weight of the gaseous reaction stream immediately prior to entering the first reactor or immediately prior to initial contact with the sorbent composition upon entering the first reactor.

2. The system of claim 1, wherein the first reactor comprises 5 wt. % or less of liquid water by weight of the sorbent composition and the liquid water.

3. The system of claim 1, wherein the gaseous reaction stream has 5 wt. % or less of condensed water by weight of the gaseous reaction stream immediately prior to entering the first reactor or immediately prior to initial contact with the sorbent composition upon entering the first reactor.

4. (canceled)

5. (canceled)

6. (canceled)

7. A system for capturing CO₂ gas, the system comprising:
a gaseous feed stream having an initial concentration of the CO₂ gas;
wherein the gaseous feed stream is directly or indirectly provided to a first reactor as a gaseous reaction stream;
the first reactor comprising a sorbent composition and the gaseous reaction stream flowing therein, the gaseous reaction stream being in contact with the sorbent composition;
a first gaseous output stream that exists the first reactor, the first gaseous output stream having a concentration of CO₂ being less than the initial concentration of CO₂ in the gaseous feed stream; and
a sorbent-regeneration subsystem;
wherein:
the gaseous reaction stream comprises the CO₂ gas and is characterized by a relative humidity of at least 5%;
the sorbent composition comprises at least one metal carbonate material that reacts with the CO₂ gas of the gaseous reaction stream thereby reducing CO₂ gas concentration in the gaseous reaction stream;
a spent-sorbent composition from the first reactor is provided to a sorbent-regeneration subsystem;
the spent-sorbent composition comprises a metal bicarbonate material formed in the first reactor as a result of the reaction of the at least one metal carbonate material with the CO₂ gas;
the sorbent-regeneration subsystem converts the provided spent-sorbent composition to a regenerated-sorbent composition; and
the regenerated-sorbent composition is recycled back to the first reactor.

8. (canceled)

9. The system of claim 1, wherein a spent-sorbent composition from the first reactor is provided to a sorbent-regeneration subsystem; wherein the spent-sorbent composition comprises a metal bicarbonate material formed in the first reactor as a result of the reaction of the at least one metal carbonate material with the CO₂ gas; wherein the sorbent-regeneration subsystem converts the provided spent-sorbent composition to a regenerated-sorbent composition; and wherein the regenerated-sorbent composition is recycled back to the first reactor; wherein the sorbent-regeneration subsystem decomposes the metal bicarbonate material to reform the at least one metal carbonate material and wherein the sorbent-regeneration subsystem further generates a product gaseous stream having CO₂ gas.

10. (canceled)

11. The system of claim 9, wherein the sorbent-regeneration subsystem granulates the reformed metal carbon material to increase particulate size and make the regenerated-sorbent composition having a larger particulate size than the spent-sorbent composition.

12. The system of claim 11, wherein spheronization is further performed to make the regenerated-sorbent composition.

13. The system of claim 9, wherein the sorbent-regeneration subsystem comprises a second reactor in which the metal bicarbonate is decomposed at an absolute pressure selected from the range of greater than 0 bar absolute (bara) to less than or equal to 20 bar absolute (bara) and/or the sorbent-regeneration subsystem comprises a second reactor in which the metal bicarbonate is decomposed at a temperature selected from the range of 20° C. to 200° C. and/or the sorbent-regeneration subsystem comprises a second reactor in which the metal bicarbonate material is decomposed at a pressure that is less than the pressure at which the at least one metal carbonate material reacts in the first reactor.

14. (canceled)

15. (canceled)

16. (canceled)

17. The system of claim 9 comprising a spent-sorbent collection subsystem configured to collect the spent-sorbent composition from the first reactor and transfer the collected spent-sorbent composition to the sorbent-regeneration subsystem; wherein the metal bicarbonate collection subsystem separates metal bicarbonate from the gaseous reaction stream or from the first gaseous output stream via gravity, one or more cyclones, one or more filters, one or more electrostatic separators, or any combination of these.

18. (canceled)

19. The system of claim 9, wherein the sorbent-regeneration subsystem decomposes the metal bicarbonate, regenerates one or more of the at least one metal carbonate material, and generates CO₂ gas according to formula FX3:
Mₓ(HCO₃)₂(s)→MₓCO₃(s)+CO₂(g)+H₂O(g) (FX3); wherein:
x is 1 or 2.

20. The system of claim 9, wherein the generated CO₂ gas is concentrated, liquefied, and/or stored.

21. The system of claim 9, wherein the sorbent-regeneration subsystem comprises a mixer, an extruder, granulator, an4 spheronizer and/or a dryer for making the regenerated-sorbent composition

22. The system of claim 9, wherein the regenerated-sorbent composition comprises one or more of the at least one metal carbonate material and is characterized by an average particulate size being within 20% of the average particulate size of the sorbent composition prior to regeneration.

23. The system of claim 9, wherein the regenerated-sorbent composition has an average particulate size selected from the range of 30 μm to 1 cm.

24. (canceled)

25. (canceled)

26. (canceled)

27. The system of claim 9, wherein the sorbent-regeneration subsystem comprises adding fresh metal carbonate material and/or fresh additive to make the regenerated-sorbent composition.

28. (canceled)

29. The system of claim 1, further comprising a feed pre-treatment subsystem configured to pre-treat the gaseous feed stream thereby forming a pre-treated gaseous stream which is provided to the first reactor; wherein the gaseous reaction stream is the pre-treated gaseous stream that enters the first reactor.

30. The system of claim 29, wherein the feed pre-treatment subsystem comprises a water-removal device configured to remove liquid water from the gaseous feed stream immediately prior to its entering the first reactor or immediately prior to initial contact with the sorbent composition in the first reactor.

31. The system of claim 29, wherein the feed pre-treatment subsystem comprises a humidifier configured to increase the relative humidity of the gaseous feed stream prior to the first reactor, such that the pre-treated gaseous stream has a higher relative humidity than the gaseous feed stream prior to pre-treatment.

32. The system of claim 29, wherein the feed pre-treatment subsystem comprises a heat-exchanger configured to cool the gaseous feed stream to facilitate removal of liquid water therefrom and/or wherein the feed pre-treatment subsystem comprises a heat-exchanger configured to heat the gaseous feed stream or pre-treated gaseous stream to a temperature greater than its dew point.

33. (canceled)

34. The system of claim 29, wherein the feed pre-treatment subsystem converts the gaseous feed stream to a pre-treated gaseous stream characterized by a relative humidity of at least 50% and a temperature being at least 0.5° C. greater than the dew point thereof.

35. The system of claim 1, wherein the first reactor comprises 15 wt. % or less of liquid water by weight of sorbent and liquid water.

36. (canceled)

37. The system of claim 1, wherein the gaseous reaction stream has 15 wt. % or less of condensed water immediately prior to entering the first reactor or immediately prior to initial contact with the sorbent composition upon entering the first reactor.

38. (canceled)

39. The system of claim 1, wherein each of the at least one metal carbonate material is characterized by formula FX1:
Mₓ(CO₃)_{y} (FX1); wherein:
M is a metal element; and
each of x and y is independently a number.

40. The system of claim 39, wherein:
M is a Group I or Group II metal element;
x is 1 or 2; and
y is 1.

41. The system of claim 1, wherein each of the at least one metal carbonate material is K₂CO₃, Na₂CO₃, or CaCO₃.

42. The system of claim 1, wherein the sorbent composition is free of a support material for the metal carbonate.

43. The system of claim 1, wherein the sorbent composition comprises one or more support materials for one or more of the at least one metal carbonate material; wherein the one or more support materials comprise one or more zeolite materials, an activated carbon material, a ceramic material, or a combination thereof.

44. (canceled)

45. The system of claim 1, wherein the at least one metal carbonate material is in the form of particulates characterized by an average particulate size selected from the range of 30 nm to 1 cm.

46. (canceled)

47. (canceled)

48. The system of claim 1, wherein the sorbent composition further comprises one or more additives; wherein the one or more additives comprise one or more binders, one or more pore expanders, one or more cross-linkers, one or more lubricants, one or more extrusion aids, or any combination thereof.

49. (canceled)

50. The system of claim 1, wherein the at least one metal carbonate material reacts with the CO₂ gas in the first reactor according to formula FX2:
MₓCO₃(s)+CO₂(g)+H₂O(g)↔Mₓ(HCO₃)₂(s) (FX2); wherein:
M is a metal element; and
x is 1 or 2.

51. The system of claim 1, wherein the gaseous reaction stream is characterized by:
a temperature being greater than its dew point in the first reactor; and/or
a temperature being 1° C. to 50° C. greater than its dew point in the first reactor.

52. (canceled)

53. The system of claim 51, wherein the gaseous reaction stream is characterized by a temperature selected from the range of 20° C. to 70° C. in the first reactor.

54. The system of claim 51, wherein the gaseous reaction stream is characterized by a relative humidity being at least 75%.

55. The system of claim 1, wherein the pressure in the first reactor is selected from the range of greater than 0 bara to less than or equal to 20 bara.

56. The system of claim 1, wherein the first gaseous output stream is characterized by a CO₂ concentration being 20% or less of the initial concentration of CO₂ in the gaseous feed stream.

57. The system of claim 1, wherein the first reactor is a fixed bed reactor.

58. (canceled)

59. The system of claim 57, wherein the spent-absorbent composition exits the first reactor in an aqueous slurry and wherein the aqueous slurry is provided to the sorbent-regeneration subsystem with or without prior separating the spent-sorbent composition from liquid water.

60. The system of claim 57, wherein the second reactor of the sorbent-regeneration subsystem is the same as the first reactor.

61. The system of claim 1, wherein the first reactor is a fluidized bed reactor.

62. (canceled)

63. The system of claim 61, wherein the spent-sorbent composition exits the first reactor with the first gaseous output stream as particulates suspended therein; and wherein the sorbent-regeneration subsystem comprises one or more cyclones to separate out particulates of the spent-sorbent composition from CO₂ gas.

64. The system of claim 61, wherein the first reactor is operated continuously and wherein the second reactor of the sorbent-regeneration subsystem is different from the first reactor.

65. The system of claim 1, wherein the gaseous feed stream is air, a flue gas, or other industrial output gas.

66. (canceled)

67. A method for capturing CO₂ gas, the method comprising:
feeding, directly or indirectly, a gaseous feed stream having an initial concentration of the CO₂ gas to a first reactor as a gaseous reaction stream;
wherein the first reactor comprises a sorbent composition and the gaseous reaction stream flowing therein, the gaseous reaction stream being in contact with the sorbent composition;
wherein the gaseous reaction stream comprises the CO₂ gas and is characterized by a relative humidity of at least 5%; and
wherein the sorbent composition comprises at least one metal carbonate material; and
reacting the CO₂ gas in the gaseous reactions stream with the at least one metal carbonate material thereby reducing CO₂ gas concentration in the gaseous reaction stream;
wherein a first gaseous output stream exists the first reactor, the first gaseous output stream having a concentration of CO₂ being less than the initial concentration of CO₂ in the gaseous feed stream; and wherein:
(a) the first reactor comprises 35 wt. % or less of liquid water by weight of the sorbent composition and the liquid water; and/or
(b) the gaseous reaction stream has 35 wt. % or less of condensed water by weight of the gaseous reaction stream immediately prior to entering the first reactor or immediately prior to initial contact with the sorbent composition upon entering the first reactor.

68. (canceled)

69. (canceled)

70. (canceled)

71. (canceled)

72. (canceled)

73. (canceled)

74. A method for capturing CO₂ gas, the method comprising:
feeding, directly or indirectly, a gaseous feed stream having an initial concentration of the CO₂ gas to a first reactor as a gaseous reaction stream;
wherein the first reactor comprises a sorbent composition and the gaseous reaction stream flowing therein, the gaseous reaction stream being in contact with the sorbent composition;
wherein the gaseous reaction stream comprises the CO₂ gas and is characterized by a relative humidity of at least 5%; and
wherein the sorbent composition comprises at least one metal carbonate material;
reacting the CO₂ gas in the gaseous reactions stream with the at least one metal carbonate material thereby reducing CO₂ gas concentration in the gaseous reaction stream;
wherein a first gaseous output stream exists the first reactor, the first gaseous output stream having a concentration of CO₂ being less than the initial concentration of CO₂ in the gaseous feed stream; and
wherein a spent-sorbent composition comprising a metal bicarbonate material is formed in the first reactor as a result of the reaction of the at least one metal carbonate material with the CO₂ gas;
regenerating the sorbent composition via a sorbent-regeneration subsystem by converting the provided spent-sorbent composition to a regenerated-sorbent composition; and
recycling the regenerated-sorbent composition back to the first reactor.

75. (canceled)

76. (canceled)

77. (canceled)

78. (canceled)

79. (canceled)
